(19) United States
(12) Patent Application Publication
(10) Pub. No.: US 2024/0259242 A1
(43) Pub. Date: Aug. 1, 2024

(54) METHOD AND DEVICE FOR CONFIGURING TRIGGER FRAME INCLUDING CONTROL INFORMATION FOR DL A-PPDU IN WLAN SYSTEM

(71) Applicant: LG ELECTRONICS INC., Seoul (KR)

(72) Inventors: Eunsung PARK, Seoul (KR); Jinyoung CHUN, Seoul (KR); Jinsoo CHOI, Seoul (KR); Dongguk LIM, Seoul (KR)

(73) Assignee: LG ELECTRONICS INC., Seoul (KR)

(21) Appl. No.: 18/566,539

(22) PCT Filed: May 31, 2022
(86) PCT No.: PCT/KR2022/007711

§ 371 Date: Dec. 1, 2023

(30) Foreign Application Priority Data
Jun. 8, 2021 (KR) 10-2021-0074276

(51) Int. Cl. H04L 27/26; H04W 72/04; H04W 72/20; H04W 84/12

(52) U.S. Cl. CPC H04L 27/2602; H04W 72/04; H04W 72/20; H04W 84/12

(57) ABSTRACT

The present disclosure proposes a method and a device for configuring a trigger frame including control information for DL A-PPDU in a WLAN system. Specifically, a receiving STA receives a trigger frame from a transmitting STA. The receiving STA receives, from the transmitting STA, a triggered DL A-PPDU on the basis of the trigger frame. The trigger frame includes a common information field, an HE modified user information field, and an EHT modified user information field. The common information field includes a trigger type subfield, a DL BW subfield, a DL BW Extension subfield, and a first reserved subfield. The HE modified user information field includes a first AID12 subfield, a first RU allocation subfield, and a second reserved subfield. The EHT modified user information field includes a second AID12 subfield, a second RU allocation subfield, and a PS160 subfield.

### CROSS-REFERENCE TO RELATED APPLICATION(S)

This application is the National Stage filing under 35 U.S.C. 371 of International Application No. PCT/KR2022/007711, filed on May 31, 2022, which claims the benefit of earlier filing date and right of priority to Korean Application No. 10-2021-0074276 filed on Jun. 8, 2021, the contents of which are all incorporated by reference herein in their entirety.

### TECHNICAL FIELD

The present disclosure relates to a method for newly defining a trigger frame in a WLAN system, and more particularly, to a method and apparatus for configuring a trigger frame including control information for a DL A-PPDU.

### BACKGROUND

A wireless local area network (WLAN) has been improved in various ways. For example, the IEEE 802.11ax standard proposed an improved communication environment using orthogonal frequency division multiple access (OFDMA) and downlink multi-user multiple input multiple output (DL MU MIMO) techniques.

The present specification proposes a technical feature that can be utilized in a new communication standard. For example, the new communication standard may be an extreme high throughput (EHT) standard which is currently being discussed. The EHT standard may use an increased bandwidth, an enhanced PHY layer protocol data unit (PPDU) structure, an enhanced sequence, a hybrid automatic repeat request (HARQ) scheme, or the like, which is newly proposed. The EHT standard may be called the IEEE 802.11be standard.

In a new WLAN standard, an increased number of spatial streams may be used. In this case, in order to properly use the increased number of spatial streams, a signaling technique in the WLAN system may need to be improved.

### SUMMARY

The present specification proposes a method and apparatus for configuring a trigger frame including control information for a DL A-PPDU in a WLAN system.

An example of the present specification proposes a method for configuring a trigger frame including control information for a DL A-PPDU.

The present embodiment may be performed in a network environment in which a next generation WLAN system (IEEE 802.11be or EHT WLAN system) is supported. The next generation wireless LAN system is a WLAN system that is enhanced from an 802.11ax system and may, therefore, satisfy backward compatibility with the 802.11ax system.

This embodiment is performed by a receiving station (STA), and the receiving STA may correspond to a non-access point (non-AP) STA. The transmitting STA may correspond to an AP STA.

This embodiment proposes a method in which an AP configures a trigger frame to trigger a DL A-PPDU in which a HE PPDU and an EHT PPDU are transmitted simultaneously. An EHT STA that received the trigger frame can receive control information for the DL A-PPDU through the trigger frame.

A receiving station (STA) receives a trigger frame from a transmitting STA.

The receiving STA receives a Downlink Aggregated-Physical Protocol Data Unit (DL A-PPDU) triggered based on the trigger frame from the transmitting STA.

The DL A-PPDU includes a High Efficiency (HE) PPDU for a primary 160 MHz channel and an Extreme High Throughput (EHT) PPDU for a secondary 160 MHz channel.

The trigger frame may include a common information field, a HE variant user information field, and an EHT variant user information field.

The common information field includes a trigger type subfield, a Downlink Bandwidth (DL BW) subfield, a DL BW Extension subfield, and a first reserved subfield.

The HE variant user information field includes a first AID12 subfield, a first Resource Unit (RU) allocation subfield, and a second reserved subfield.

The EHT variant user information field includes a second AID12 subfield, a second RU allocation subfield, and a PS160 subfield.

A bit position of the second reserved subfield in the HE variant user information field is the same as a bit position of the PS160 subfield in the EHT variant user information field.

The trigger type subfield may include information on a type of the trigger frame. When a value of the trigger type subfield is 8, the trigger frame may be set to a type that triggers the DL A-PPDU.

The embodiment proposes a method in which the transmitting STA newly defines a trigger frame that triggers the DL A-PPDU and transmits the trigger frame with minimum information compared to an existing trigger frame.

According to the embodiment proposed in this specification, when the transmitting STA transmits the DL A-PPDU based on the trigger frame, even when Subchannel Selective Transmission (SST) is not used, there is an effect that an EHT STA can be effectively assigned to the channel on which the HE PPDU and the EHT PPDU are transmitted.

### BRIEF DESCRIPTION OF THE DRAWINGS

FIG. 1 shows an example of a transmitting apparatus and/or receiving apparatus of the present specification.

FIG. 2 is a conceptual view illustrating the structure of a wireless local area network (WLAN).

FIG. 3 illustrates a general link setup process.

FIG. 4 illustrates an example of a PPDU used in an IEEE standard.

FIG. 5 illustrates a layout of resource units (RUS) used in a band of 20 MHz.

FIG. 6 illustrates a layout of RUs used in a band of 40 MHz.

FIG. 7 illustrates a layout of RUs used in a band of 80 MHz.

FIG. 8 illustrates a structure of an HE-SIG-B field.

FIG. 9 illustrates an example in which a plurality of user STAs are allocated to the same RU through a MU-MIMO scheme.

FIG. 10 illustrates an example of a PPDU used in the present specification.

FIG. 11 illustrates an example of a modified transmission device and/or receiving device of the present specification.

FIG. 12 is a diagram of a representative A-PPDU.

FIG. 13 shows the structure of a U-SIG.

FIG. 14 shows the structure of a trigger frame.

FIG. 15 shows the format of an HE variant Common Info field.

FIG. 16 shows the format of an EHT variant Common Info field.

FIG. 17 shows an example of a Special User Info field format.

FIG. 18 shows an example of an HE Variant User Info field format.

FIG. 19 shows an example of an EHT Variant User Info field format.

FIG. 20 shows an example of a SS Allocation subfield format.

FIG. 21 is a process flow diagram illustrating the operation of the transmitting device according to this embodiment.

FIG. 22 is a process flow diagram illustrating the operation of the receiving device according to the present embodiment.

FIG. 23 is a flowchart illustrating a procedure in which a transmitting STA transmits a trigger frame that triggers a DL A-PPDU according to this embodiment.

FIG. 24 is a flowchart illustrating a procedure in which a receiving STA receives a trigger frame that triggers a DL A-PPDU according to this embodiment.

### DETAILED DESCRIPTION

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (EHT-signal)”, it may denote that “EHT-signal” is proposed as an example of the “control information”. In other words, the “control information” of the present specification is not limited to “EHT-signal”, and “EHT-signal” may be proposed as an example of the “control information”. In addition, when indicated as “control information (i.e., EHT-signal)”, it may also mean that “EHT-signal” is proposed as an example of the “control information”.

Technical features described individually in one figure in the present specification may be individually implemented, or may be simultaneously implemented.

The following example of the present specification may be applied to various wireless communication systems. For example, the following example of the present specification may be applied to a wireless local area network (WLAN) system. For example, the present specification may be applied to the IEEE 802.11a/g/n/ac standard or the IEEE 802.11ax standard. In addition, the present specification may also be applied to the newly proposed EHT standard or IEEE 802.11be standard. In addition, the example of the present specification may also be applied to a new WLAN standard enhanced from the EHT standard or the IEEE 802.11be standard. In addition, the example of the present specification may be applied to a mobile communication system. For example, it may be applied to a mobile communication system based on long term evolution (LTE) depending on a 3^{rd} generation partnership project (3GPP) standard and based on evolution of the LTE. In addition, the example of the present specification may be applied to a communication system of a 5G NR standard based on the 3GPP standard.

Hereinafter, in order to describe a technical feature of the present specification, a technical feature applicable to the present specification will be described.

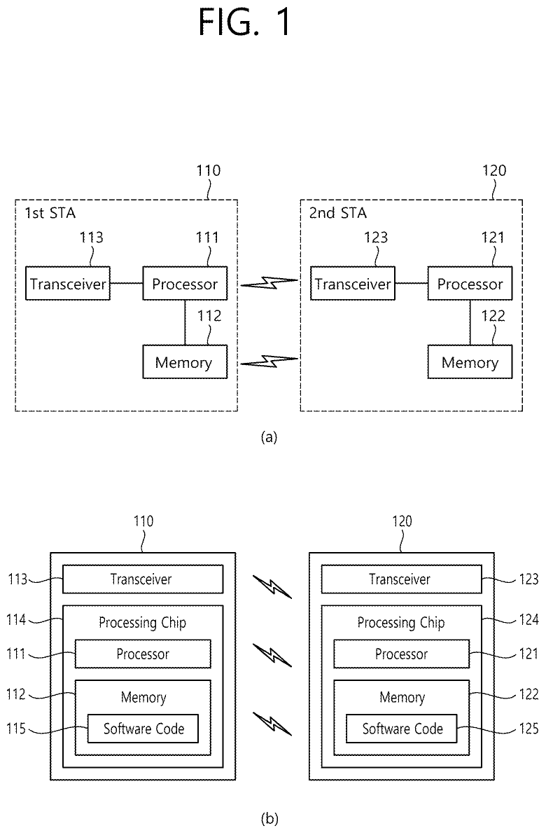

FIG. 1 shows an example of a transmitting apparatus and/or receiving apparatus of the present specification.

In the example of FIG. 1, various technical features described below may be performed. FIG. 1 relates to at least one station (STA). For example, STAs 110 and 120 of the present specification may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present specification may also be called in various terms such as a network, a base station, a node-B, an access point (AP), a repeater, a router, a relay, or the like. The STAs 110 and 120 of the present specification may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present specification may serve as the AP and/or the non-AP.

The STAs 110 and 120 of the present specification may support various communication standards together in addition to the IEEE 802.11 standard. For example, a communication standard (e.g., LTE, LTE-A, 5G NR standard) or the like based on the 3GPP standard may be supported. In addition, the STA of the present specification may be implemented as various devices such as a mobile phone, a vehicle, a personal computer, or the like. In addition, the STA of the present specification may support communication for various communication services such as voice calls, video calls, data communication, and self-driving (autonomous-driving), or the like.

The STAs 110 and 120 of the present specification may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the specification described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the specification described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the specification described below, a device called a (transmitting/receiving) STA, a first STA, a second STA, a STA1, a STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU: 2) an operation of determining/configuring/obtaining a time resource or frequency resource (e.g., a subcarrier resource) or the like used for the sub-field (SIG, STF, LTF, Data) included the PPDU: 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU: 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present specification will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present specification may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or processors enhanced from these processors.

In the present specification, an uplink may imply a link for communication from a non-AP STA to an SP STA, and an uplink PPDU/packet/signal or the like may be transmitted through the uplink. In addition, in the present specification, a downlink may imply a link for communication from the AP STA to the non-AP STA, and a downlink PPDU/packet/signal or the like may be transmitted through the downlink.

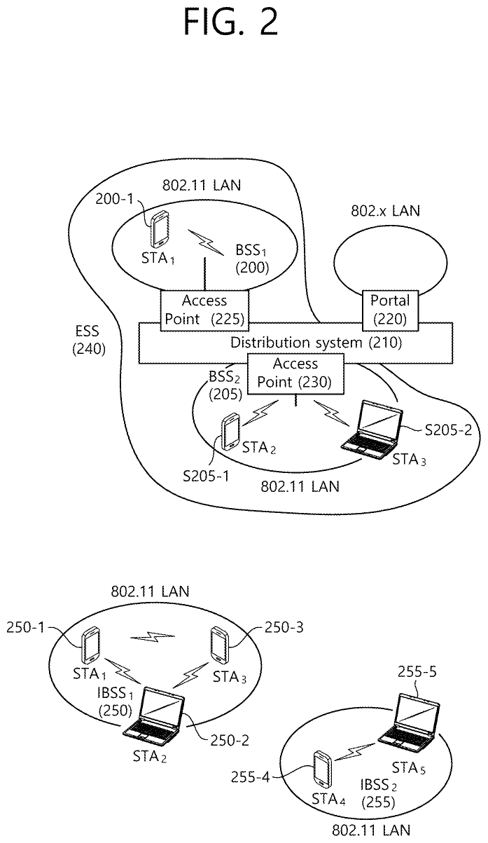

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and a STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

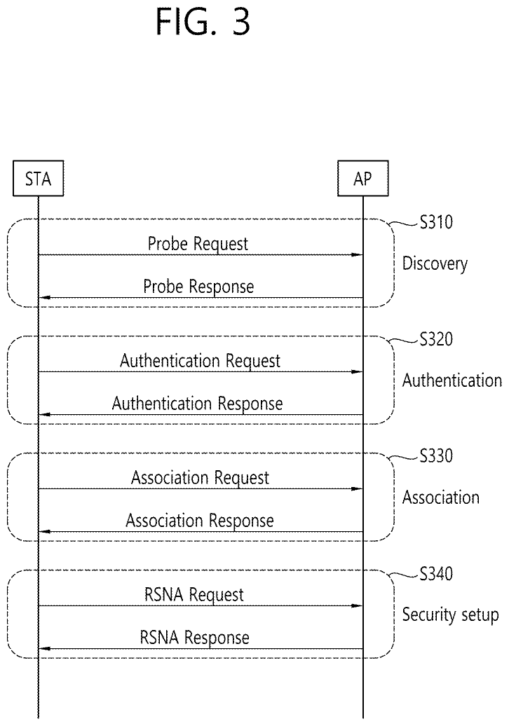

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information related to a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information related to an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information related to various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information related to various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

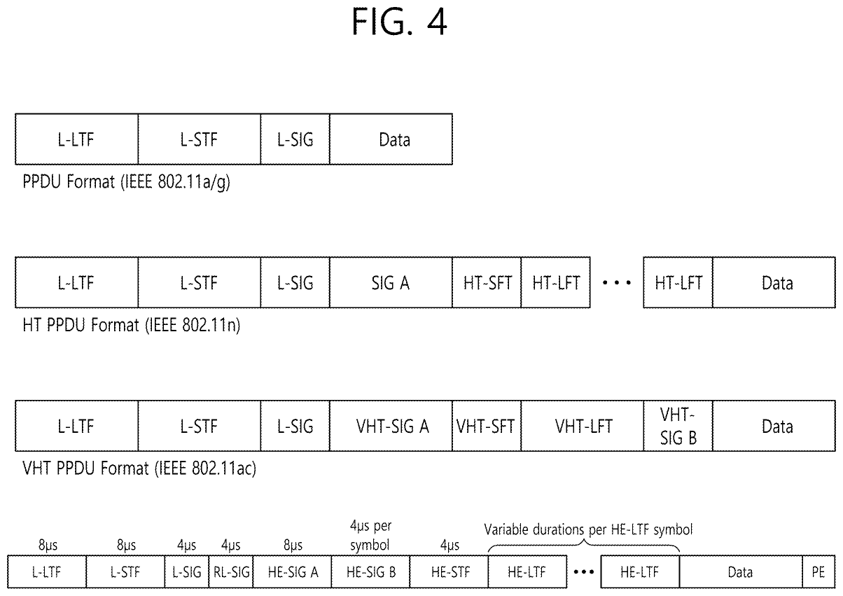

FIG. 4 illustrates an example of a PPDU used in an IEEE standard.

As illustrated, various types of PHY protocol data units (PPDUs) are used in IEEE a/g/n/ac standards. Specifically, an LTF and a STF include a training signal, a SIG-A and a SIG-B include control information for a receiving STA, and a data field includes user data corresponding to a PSDU (MAC PDU/aggregated MAC PDU).

FIG. 4 also includes an example of an HE PPDU according to IEEE 802.11ax. The HE PPDU according to FIG. 4 is an illustrative PPDU for multiple users. An HE-SIG-B may be included only in a PPDU for multiple users, and an HE-SIG-B may be omitted in a PPDU for a single user.

As illustrated in FIG. 4, the HE-PPDU for multiple users (MUS) may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), a data field (alternatively, an MAC payload), and a packet extension (PE) field. The respective fields may be transmitted for illustrated time periods (i.e., 4 or 8 μs).

Hereinafter, a resource unit (RU) used for a PPDU is described. An RU may include a plurality of subcarriers (or tones). An RU may be used to transmit a signal to a plurality of STAs according to OFDMA. Further, an RU may also be defined to transmit a signal to one STA. An RU may be used for an STF, an LTF, a data field, or the like.

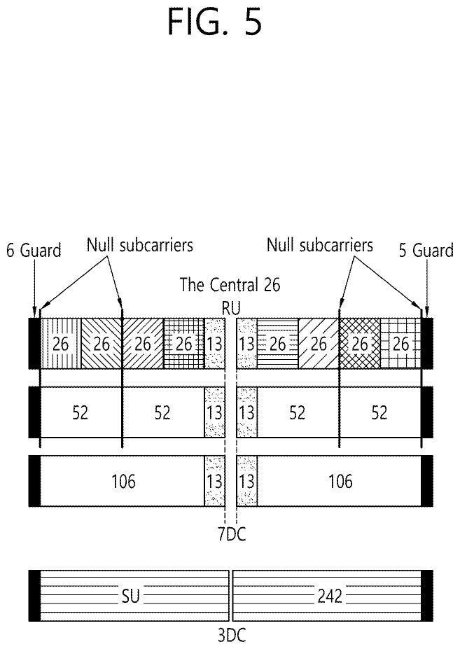

FIG. 5 illustrates a layout of resource units (RUs) used in a band of 20 MHz.

As illustrated in FIG. 5, resource units (RUs) corresponding to different numbers of tones (i.e., subcarriers) may be used to form some fields of an HE-PPDU. For example, resources may be allocated in illustrated RUs for an HE-STF, an HE-LTF, and a data field.

As illustrated in the uppermost part of FIG. 5, a 26-unit (i.e., a unit corresponding to 26 tones) may be disposed. Six tones may be used for a guard band in the leftmost band of the 20 MHz band, and five tones may be used for a guard band in the rightmost band of the 20 MHz band. Further, seven DC tones may be inserted in a center band, that is, a DC band, and a 26-unit corresponding to 13 tones on each of the left and right sides of the DC band may be disposed. A 26-unit, a 52-unit, and a 106-unit may be allocated to other bands. Each unit may be allocated for a receiving STA, that is, a user.

The layout of the RUs in FIG. 5 may be used not only for a multiple users (MUs) but also for a single user (SU), in which case one 242-unit may be used and three DC tones may be inserted as illustrated in the lowermost part of FIG. 5.

Although FIG. 5 proposes RUs having various sizes, that is, a 26-RU, a 52-RU, a 106-RU, and a 242-RU, specific sizes of RUs may be extended or increased. Therefore, the present embodiment is not limited to the specific size of each RU (i.e., the number of corresponding tones).

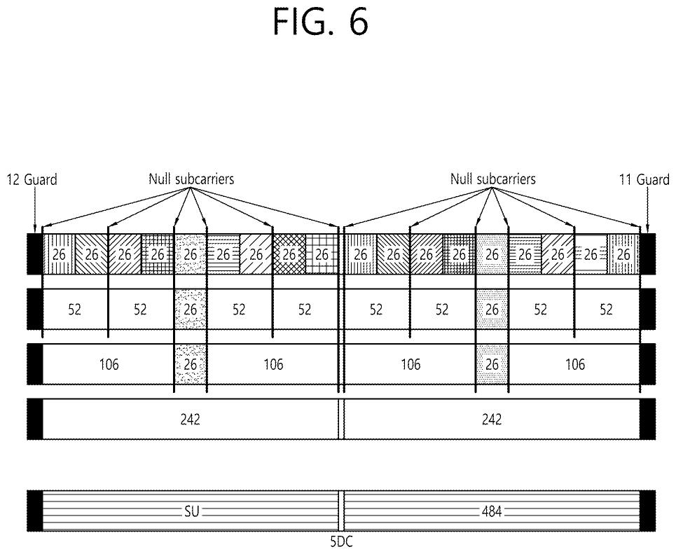

FIG. 6 illustrates a layout of RUs used in a band of 40 MHz.

Similarly to FIG. 5 in which RUs having various sizes are used, a 26-RU, a 52-RU, a 106-RU, a 242-RU, a 484-RU, and the like may be used in an example of FIG. 6. Further, five DC tones may be inserted in a center frequency, 12 tones may be used for a guard band in the leftmost band of the 40 MHz band, and 11 tones may be used for a guard band in the rightmost band of the 40 MHz band.

As illustrated in FIG. 6, when the layout of the RUs is used for a single user, a 484-RU may be used. The specific number of RUs may be changed similarly to FIG. 5.

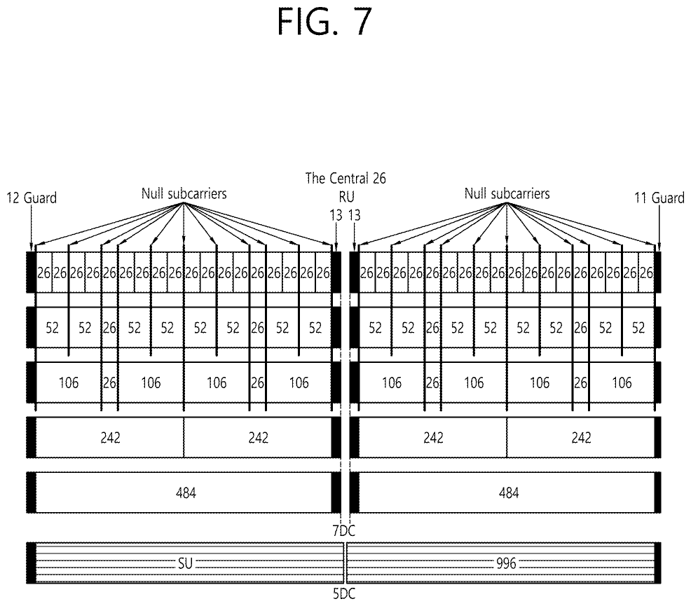

FIG. 7 illustrates a layout of RUs used in a band of 80 MHz.

Similarly to FIG. 5 and FIG. 6 in which RUs having various sizes are used, a 26-RU, a 52-RU, a 106-RU, a 242-RU, a 484-RU, a 996-RU, and the like may be used in an example of FIG. 7. Further, seven DC tones may be inserted in the center frequency, 12 tones may be used for a guard band in the leftmost band of the 80 MHz band, and 11 tones may be used for a guard band in the rightmost band of the 80 MHz band. In addition, a 26-RU corresponding to 13 tones on each of the left and right sides of the DC band may be used.

As illustrated in FIG. 7, when the layout of the RUs is used for a single user, a 996-RU may be used, in which case five DC tones may be inserted.

The RU described in the present specification may be used in uplink (UL) communication and downlink (DL) communication. For example, when UL-MU communication which is solicited by a trigger frame is performed, a transmitting STA (e.g., an AP) may allocate a first RU (e.g., 26/52/106/242-RU, etc.) to a first STA through the trigger frame, and may allocate a second RU (e.g., 26/52/106/242-RU, etc.) to a second STA. Thereafter, the first STA may transmit a first trigger-based PPDU based on the first RU, and the second STA may transmit a second trigger-based PPDU based on the second RU. The first/second trigger-based PPDU is transmitted to the AP at the same (or overlapped) time period.

For example, when a DL MU PPDU is configured, the transmitting STA (e.g., AP) may allocate the first RU (e.g., 26/52/106/242-RU. etc.) to the first STA, and may allocate the second RU (e.g., 26/52/106/242-RU, etc.) to the second STA. That is, the transmitting STA (e.g., AP) may transmit HE-STF, HE-LTF, and Data fields for the first STA through the first RU in one MU PPDU, and may transmit HE-STF, HE-LTF, and Data fields for the second STA through the second RU.

Information related to a layout of the RU may be signaled through HE-SIG-B.

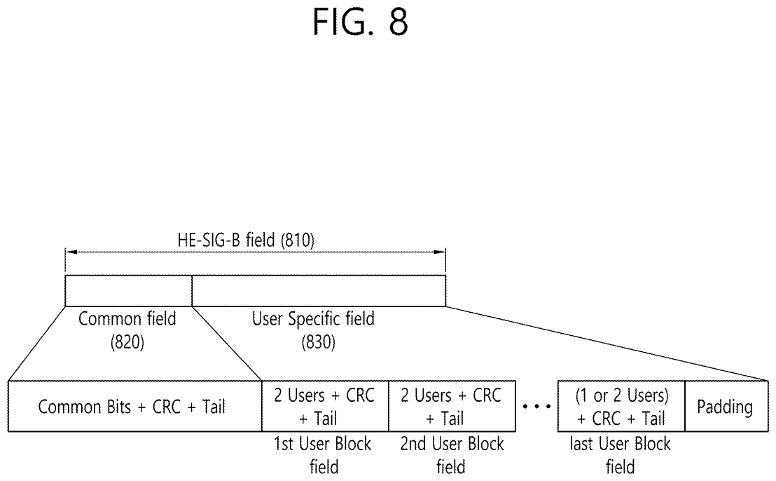

FIG. 8 illustrates a structure of an HE-SIG-B field.

As illustrated, an HE-SIG-B field 810 includes a common field 820 and a user-specific field 830. The common field 820 may include information commonly applied to all users (i.e., user STAs) which receive SIG-B. The user-specific field 830 may be called a user-specific control field. When the SIG-B is transferred to a plurality of users, the user-specific field 830 may be applied only any one of the plurality of users.

As illustrated in FIG. 8, the common field 820 and the user-specific field 830 may be separately encoded.

The common field 820 may include RU allocation information of N*8 bits. For example, the RU allocation information may include information related to a location of an RU. For example, when a 20 MHz channel is used as shown in FIG. 5, the RU allocation information may include information related to a specific frequency band to which a specific RU (26-RU/52-RU/106-RU) is arranged.

An example of a case in which the RU allocation information consists of 8 bits is as follows.

TABLE 1

| RU Allocation | | | | | | | | | | |
|---|---|---|---|---|---|---|---|---|---|---|
| subfield | | | | | | | | | | |
| (B7 B6 B5 B4 | | | | | | | | | | Number |
| B3 B2 B1 B0) | #1 | #2 | #3 | #4 | #5 | #6 | #7 | #8 | #9 | of entries |
| 00000000 | 26 | 26 | 26 | 26 | 26 | 26 | 26 | 26 | 26 | 1 |

| | | | | | | | | | |
|---|---|---|---|---|---|---|---|---|---|
| 00000001 | 26 | 26 | 26 | 26 | 26 | 26 | 26 | 52 | 1 |

| | | | | | | | | | |
|---|---|---|---|---|---|---|---|---|---|
| 00000010 | 26 | 26 | 26 | 26 | 26 | 52 | 26 | 26 | 1 |

| | | | | | | | | |
|---|---|---|---|---|---|---|---|---|
| 00000011 | 26 | 26 | 26 | 26 | 26 | 52 | 52 | 1 |

| | | | | | | | | | |
|---|---|---|---|---|---|---|---|---|---|
| 00000100 | 26 | 26 | 52 | 26 | 26 | 26 | 26 | 26 | 1 |

| | | | | | | | | |
|---|---|---|---|---|---|---|---|---|
| 00000101 | 26 | 26 | 52 | 26 | 26 | 26 | 52 | 1 |

| | | | | | | | | |
|---|---|---|---|---|---|---|---|---|
| 00000110 | 26 | 26 | 52 | 26 | 52 | 26 | 26 | 1 |

| | | | | | | | |
|---|---|---|---|---|---|---|---|
| 00000111 | 26 | 26 | 52 | 26 | 52 | 52 | 1 |

| | | | | | | | | | |
|---|---|---|---|---|---|---|---|---|---|
| 00001000 | 52 | 26 | 26 | 26 | 26 | 26 | 26 | 26 | 1 |

| | | | | | | | | |
|---|---|---|---|---|---|---|---|---|
| 00001001 | 52 | 26 | 26 | 26 | 26 | 26 | 52 | 1 |

| | | | | | | | | |
|---|---|---|---|---|---|---|---|---|
| 00001010 | 52 | 26 | 26 | 26 | 52 | 26 | 26 | 1 |

As shown the example of FIG. 5, up to nine 26-RUs may be allocated to the 20 MHz channel. When the RU allocation information of the common field 820 is set to “00000000” as shown in Table 1, the nine 26-RUs may be allocated to a corresponding channel (i.e., 20 MHz). In addition, when the RU allocation information of the common field 820 is set to “00000001” as shown in Table 1, seven 26-RUs and one 52-RU are arranged in a corresponding channel. That is, in the example of FIG. 5, the 52-RU may be allocated to the rightmost side, and the seven 26-RUs may be allocated to the left thereof.

The example of Table 1 shows only some of RU locations capable of displaying the RU allocation information.

For example, the RU allocation information may include an example of Table 2 below.

TABLE 2

| 8 bits indices | | | | | | | | | | |
|---|---|---|---|---|---|---|---|---|---|---|
| (B7 B6 B5 B4 | | | | | | | | | | Number |
| B3 B2 B1 B0) | #1 | #2 | #3 | #4 | #5 | #6 | #7 | #8 | #9 | of entries |

| | | | | | | | |
|---|---|---|---|---|---|---|---|
| 01000y₂y₁y₀ | 106 | 26 | 26 | 26 | 26 | 26 | 8 |

| | | | | | | |
|---|---|---|---|---|---|---|
| 01001y₂y₁y₀ | 106 | 26 | 26 | 26 | 52 | 8 |

“01000y2y1y0” relates to an example in which a 106-RU is allocated to the leftmost side of the 20 MHz channel, and five 26-RUs are allocated to the right side thereof. In this case, a plurality of STAs (e.g., user-STAs) may be allocated to the 106-RU, based on a MU-MIMO scheme. Specifically, up to 8 STAs (e.g., user-STAs) may be allocated to the 106-RU, and the number of STAs (e.g., user-STAs) allocated to the 106-RU is determined based on 3-bit information (y2y1y0). For example, when the 3-bit information (y2y1y0) is set to N, the number of STAs (e.g., user-STAs) allocated to the 106-RU based on the MU-MIMO scheme may be N+1.

In general, a plurality of STAs (e.g., user STAs) different from each other may be allocated to a plurality of RUs. However, the plurality of STAs (e.g., user STAs) may be allocated to one or more RUs having at least a specific size (e.g., 106 subcarriers), based on the MU-MIMO scheme.

As shown in FIG. 8, the user-specific field 830 may include a plurality of user fields. As described above, the number of STAs (e.g., user STAs) allocated to a specific channel may be determined based on the RU allocation information of the common field 820. For example, when the RU allocation information of the common field 820 is “00000000”, one user STA may be allocated to each of nine 26-RUs (e.g., nine user STAs may be allocated). That is, up to 9 user STAs may be allocated to a specific channel through an OFDMA scheme. In other words, up to 9 user STAs may be allocated to a specific channel through a non-MU-MIMO scheme.

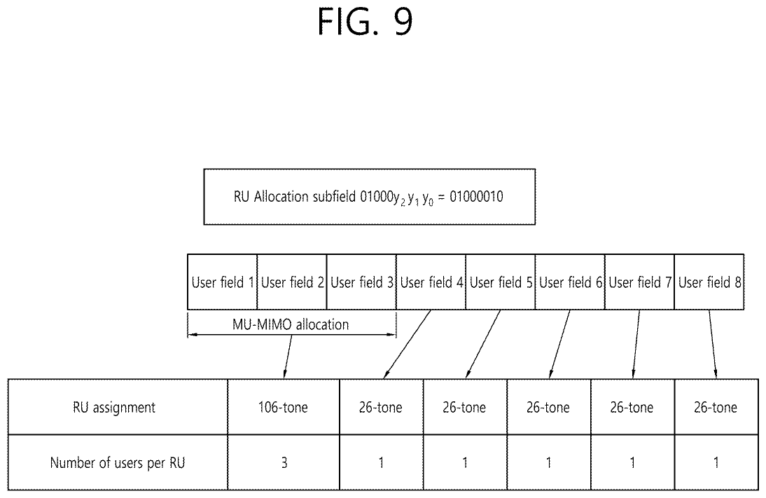

For example, when RU allocation is set to “01000y2y1y0”, a plurality of STAs may be allocated to the 106-RU arranged at the leftmost side through the MU-MIMO scheme, and five user STAs may be allocated to five 26-RUs arranged to the right side thereof through the non-MU MIMO scheme. This case is specified through an example of FIG. 9.

FIG. 9 illustrates an example in which a plurality of user STAs are allocated to the same RU through a MU-MIMO scheme.

For example, when RU allocation is set to “01000010” as shown in FIG. 9, a 106-RU may be allocated to the leftmost side of a specific channel, and five 26-RUs may be allocated to the right side thereof. In addition, three user STAs may be allocated to the 106-RU through the MU-MIMO scheme. As a result, since eight user STAs are allocated, the user-specific field 830 of HE-SIG-B may include eight user fields.

The eight user fields may be expressed in the order shown in FIG. 9. In addition, as shown in FIG. 8, two user fields may be implemented with one user block field.

The user fields shown in FIG. 8 and FIG. 9 may be configured based on two formats. That is, a user field related to a MU-MIMO scheme may be configured in a first format, and a user field related to a non-MIMO scheme may be configured in a second format. Referring to the example of FIG. 9, a user field 1 to a user field 3 may be based on the first format, and a user field 4 to a user field 8 may be based on the second format. The first format or the second format may include bit information of the same length (e.g., 21 bits).

Each user field may have the same size (e.g., 21 bits). For example, the user field of the first format (the first of the MU-MIMO scheme) may be configured as follows.

For example, a first bit (i.e., B0-B10) in the user field (i.e., 21 bits) may include identification information (e.g., STA-ID, partial AID, etc.) of a user STA to which a corresponding user field is allocated. In addition, a second bit (i.e., B11-B14) in the user field (i.e., 21 bits) may include information related to a spatial configuration.

In addition, a third bit (i.e., B15-18) in the user field (i.e., 21 bits) may include modulation and coding scheme (MCS) information. The MCS information may be applied to a data field in a PPDU including corresponding SIG-B.

An MCS, MCS information, an MCS index, an MCS field, or the like used in the present specification may be indicated by an index value. For example, the MCS information may be indicated by an index 0 to an index 11. The MCS information may include information related to a constellation modulation type (e.g., BPSK, QPSK, 16-QAM, 64-QAM, 256-QAM, 1024-QAM, etc.) and information related to a coding rate (e.g., 1/2, 2/3, 3/4, 5/6e, etc.). Information related to a channel coding type (e.g., LCC or LDPC) may be excluded in the MCS information.

In addition, a fourth bit (i.e., B19) in the user field (i.e., 21 bits) may be a reserved field.

In addition, a fifth bit (i.e., B20) in the user field (i.e., 21 bits) may include information related to a coding type (e.g., BCC or LDPC). That is, the fifth bit (i.e., B20) may include information related to a type (e.g., BCC or LDPC) of channel coding applied to the data field in the PPDU including the corresponding SIG-B.

The aforementioned example relates to the user field of the first format (the format of the MU-MIMO scheme). An example of the user field of the second format (the format of the non-MU-MIMO scheme) is as follows.

A first bit (e.g., B0-B10) in the user field of the second format may include identification information of a user STA. In addition, a second bit (e.g., B11-B13) in the user field of the second format may include information related to the number of spatial streams applied to a corresponding RU. In addition, a third bit (e.g., B14) in the user field of the second format may include information related to whether a beamforming steering matrix is applied. A fourth bit (e.g., B15-B18) in the user field of the second format may include modulation and coding scheme (MCS) information. In addition, a fifth bit (e.g., B19) in the user field of the second format may include information related to whether dual carrier modulation (DCM) is applied. In addition, a sixth bit (i.e., B20) in the user field of the second format may include information related to a coding type (e.g., BCC or LDPC).

Hereinafter, a PPDU transmitted/received in a STA of the present specification will be described.

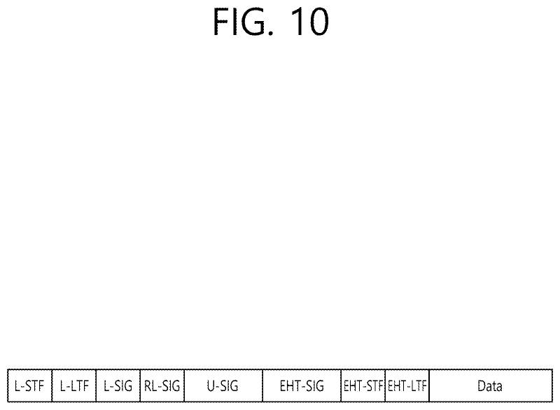

FIG. 10 illustrates an example of a PPDU used in the present specification.

The PPDU of FIG. 10 may be called in various terms such as an EHT PPDU, a TX PPDU, an RX PPDU, a first type or N-th type PPDU, or the like. For example, in the present specification, the PPDU or the EHT PPDU may be called in various terms such as a TX PPDU, a RX PPDU, a first type or N-th type PPDU, or the like. In addition, the EHT PPDU may be used in an EHT system and/or a new WLAN system enhanced from the EHT system.

The PPDU of FIG. 10 may indicate the entirety or part of a PPDU type used in the EHT system. For example, the example of FIG. 10 may be used for both of a single-user (SU) mode and a multi-user (MU) mode. In other words, the PPDU of FIG. 10 may be a PPDU for one receiving STA or a plurality of receiving STAs. When the PPDU of FIG. 10 is used for a trigger-based (TB) mode, the EHT-SIG of FIG. 10 may be omitted. In other words, an STA which has received a trigger frame for uplink-MU (UL-MU) may transmit the PPDU in which the EHT-SIG is omitted in the example of FIG. 10.

In FIG. 10, an L-STF to an EHT-LTF may be called a preamble or a physical preamble, and may be generated/transmitted/received/obtained/decoded in a physical layer.

A subcarrier spacing of the L-STF, L-LTF, L-SIG, RL-SIG, U-SIG, and EHT-SIG fields of FIG. 10 may be determined as 312.5 kHz, and a subcarrier spacing of the EHT-STF, EHT-LTF, and Data fields may be determined as 78.125 kHz. That is, a tone index (or subcarrier index) of the L-STF, L-LTF, L-SIG, RL-SIG, U-SIG, and EHT-SIG fields may be expressed in unit of 312.5 kHz, and a tone index (or subcarrier index) of the EHT-STF, EHT-LTF, and Data fields may be expressed in unit of 78.125 KHz.

In the PPDU of FIG. 10, the L-LTE and the L-STF may be the same as those in the conventional fields.

The L-SIG field of FIG. 10 may include, for example, bit information of 24 bits. For example, the 24-bit information may include a rate field of 4 bits, a reserved bit of 1 bit, a length field of 12 bits, a parity bit of 1 bit, and a tail bit of 6 bits. For example, the length field of 12 bits may include information related to a length or time duration of a PPDU. For example, the length field of 12 bits may be determined based on a type of the PPDU. For example, when the PPDU is a non-HT, HT, VHT PPDU or an EHT PPDU, a value of the length field may be determined as a multiple of 3. For example, when the PPDU is an HE PPDU, the value of the length field may be determined as “a multiple of 3”+1 or “a multiple of 3”+2. In other words, for the non-HT, HT, VHT PPDI or the EHT PPDU, the value of the length field may be determined as a multiple of 3, and for the HE PPDU, the value of the length field may be determined as “a multiple of 3”+1 or “a multiple of 3”+2.

For example, the transmitting STA may apply BCC encoding based on a 1/2 coding rate to the 24-bit information of the L-SIG field. Thereafter, the transmitting STA may obtain a BCC coding bit of 48 bits. BPSK modulation may be applied to the 48-bit coding bit, thereby generating 48 BPSK symbols. The transmitting STA may map the 48 BPSK symbols to positions except for a pilot subcarrier {subcarrier index −21, −7, +7, +21} and a DC subcarrier {subcarrier index 0}. As a result, the 48 BPSK symbols may be mapped to subcarrier indices −26 to −22, −20 to −8, −6 to −1, +1 to +6, +8 to +20, and +22 to +26. The transmitting STA may additionally map a signal of {−1, −1, −1, 1} to a subcarrier index {−28, −27, +27, +28}. The aforementioned signal may be used for channel estimation on a frequency domain corresponding to {−28, −27, +27, +28}.

The transmitting STA may generate an RL-SIG generated in the same manner as the L-SIG. BPSK modulation may be applied to the RL-SIG. The receiving STA may know that the RX PPDU is the HE PPDU or the EHT PPDU, based on the presence of the RL-SIG.

A universal SIG (U-SIG) may be inserted after the RL-SIG of FIG. 10. The U-SIB may be called in various terms such as a first SIG field, a first SIG, a first type SIG, a control signal, a control signal field, a first (type) control signal, or the like.

The U-SIG may include information of N bits, and may include information for identifying a type of the EHT PPDU. For example, the U-SIG may be configured based on two symbols (e.g., two contiguous OFDM symbols). Each symbol (e.g., OFDM symbol) for the U-SIG may have a duration of 4 μs. Each symbol of the U-SIG may be used to transmit the 26-bit information. For example, each symbol of the U-SIG may be transmitted/received based on 52 data tomes and 4 pilot tones.

Through the U-SIG (or U-SIG field), for example, A-bit information (e.g., 52 un-coded bits) may be transmitted. A first symbol of the U-SIG may transmit first X-bit information (e.g., 26 un-coded bits) of the A-bit information, and a second symbol of the U-SIB may transmit the remaining Y-bit information (e.g. 26 un-coded bits) of the A-bit information. For example, the transmitting STA may obtain 26 un-coded bits included in each U-SIG symbol. The transmitting STA may perform convolutional encoding (i.e., BCC encoding) based on a rate of R=1/2 to generate 52-coded bits, and may perform interleaving on the 52-coded bits. The transmitting STA may perform BPSK modulation on the interleaved 52-coded bits to generate 52 BPSK symbols to be allocated to each U-SIG symbol. One U-SIG symbol may be transmitted based on 65 tones (subcarriers) from a subcarrier index −28 to a subcarrier index +28, except for a DC index 0. The 52 BPSK symbols generated by the transmitting STA may be transmitted based on the remaining tones (subcarriers) except for pilot tones, i.e., tones −21, −7, +7, +21.

For example, the A-bit information (e.g., 52 un-coded bits) generated by the U-SIG may include a CRC field (e.g., a field having a length of 4 bits) and a tail field (e.g., a field having a length of 6 bits). The CRC field and the tail field may be transmitted through the second symbol of the U-SIG. The CRC field may be generated based on 26 bits allocated to the first symbol of the U-SIG and the remaining 16 bits except for the CRC/tail fields in the second symbol, and may be generated based on the conventional CRC calculation algorithm. In addition, the tail field may be used to terminate trellis of a convolutional decoder, and may be set to, for example, “000000”.

The A-bit information (e.g., 52 un-coded bits) transmitted by the U-SIG (or U-SIG field) may be divided into version-independent bits and version-dependent bits. For example, the version-independent bits may have a fixed or variable size. For example, the version-independent bits may be allocated only to the first symbol of the U-SIG, or the version-independent bits may be allocated to both of the first and second symbols of the U-SIG. For example, the version-independent bits and the version-dependent bits may be called in various terms such as a first control bit, a second control bit, or the like.

For example, the version-independent bits of the U-SIG may include a PHY version identifier of 3 bits. For example, the PHY version identifier of 3 bits may include information related to a PHY version of a TX/RX PPDU. For example, a first value of the PHY version identifier of 3 bits may indicate that the TX/RX PPDU is an EHT PPDU. In other words, when the transmitting STA transmits the EHT PPDU, the PHY version identifier of 3 bits may be set to a first value. In other words, the receiving STA may determine that the RX PPDU is the EHT PPDU, based on the PHY version identifier having the first value.

For example, the version-independent bits of the U-SIG may include a UL/DL flag field of 1 bit. A first value of the UL/DL flag field of 1 bit relates to UL communication, and a second value of the UL/DL flag field relates to DL communication.

For example, the version-independent bits of the U-SIG may include information related to a TXOP length and information related to a BSS color ID.

For example, when the EHT PPDU is divided into various types (e.g., various types such as an EHT PPDU related to an SU mode, an EHT PPDU related to a MU mode, an EHT PPDU related to a TB mode, an EHT PPDU related to extended range transmission, or the like), information related to the type of the EHT PPDU may be included in the version-dependent bits of the U-SIG.

For example, the U-SIG may include: 1) a bandwidth field including information related to a bandwidth: 2) a field including information related to an MCS scheme applied to EHT-SIG: 3) an indication field including information regarding whether a dual subcarrier modulation (DCM) scheme is applied to EHT-SIG; 4) a field including information related to the number of symbol used for EHT-SIG: 5) a field including information regarding whether the EHT-SIG is generated across a full band: 6) a field including information related to a type of EHT-LTF/STF; and 7) information related to a field indicating an EHT-LTF length and a CP length.

Preamble puncturing may be applied to the PPDU of FIG. 10. The preamble puncturing implies that puncturing is applied to part (e.g., a secondary 20 MHz band) of the full band. For example, when an 80 MHz PPDU is transmitted, an STA may apply puncturing to the secondary 20 MHz band out of the 80 MHz band, and may transmit a PPDU only through a primary 20 MHz band and a secondary 40 MHz band.

For example, a pattern of the preamble puncturing may be configured in advance. For example, when a first puncturing pattern is applied, puncturing may be applied only to the secondary 20 MHz band within the 80 MHz band. For example, when a second puncturing pattern is applied, puncturing may be applied to only any one of two secondary 20 MHz bands included in the secondary 40 MHz band within the 80 MHz band. For example, when a third puncturing pattern is applied, puncturing may be applied to only the secondary 20 MHz band included in the primary 80 MHz band within the 160 MHz band (or 80+80 MHz band). For example, when a fourth puncturing is applied, puncturing may be applied to at least one 20 MHz channel not belonging to a primary 40 MHz band in the presence of the primary 40 MHz band included in the 80 MHz band within the 160 MHz band (or 80+80 MHz band).

Information related to the preamble puncturing applied to the PPDU may be included in U-SIG and/or EHT-SIG. For example, a first field of the U-SIG may include information related to a contiguous bandwidth, and second field of the U-SIG may include information related to the preamble puncturing applied to the PPDU.

For example, the U-SIG and the EHT-SIG may include the information related to the preamble puncturing, based on the following method. When a bandwidth of the PPDU exceeds 80 MHz, the U-SIG may be configured individually in unit of 80 MHz. For example, when the bandwidth of the PPDU is 160 MHz, the PPDU may include a first U-SIG for a first 80 MHz band and a second U-SIG for a second 80 MHz band. In this case, a first field of the first U-SIG may include information related to a 160 MHz bandwidth, and a second field of the first U-SIG may include information related to a preamble puncturing (i.e., information related to a preamble puncturing pattern) applied to the first 80 MHz band. In addition, a first field of the second U-SIG may include information related to a 160 MHz bandwidth, and a second field of the second U-SIG may include information related to a preamble puncturing (i.e., information related to a preamble puncturing pattern) applied to the second 80 MHz band. Meanwhile, an EHT-SIG contiguous to the first U-SIG may include information related to a preamble puncturing applied to the second 80 MHz band (i.e., information related to a preamble puncturing pattern), and an EHT-SIG contiguous to the second U-SIG may include information related to a preamble puncturing (i.e., information related to a preamble puncturing pattern) applied to the first 80 MHz band.

Additionally or alternatively, the U-SIG and the EHT-SIG may include the information related to the preamble puncturing, based on the following method. The U-SIG may include information related to a preamble puncturing (i.e., information related to a preamble puncturing pattern) for all bands. That is, the EHT-SIG may not include the information related to the preamble puncturing, and only the U-SIG may include the information related to the preamble puncturing (i.e., the information related to the preamble puncturing pattern).

The U-SIG may be configured in unit of 20 MHz. For example, when an 80 MHz PPDU is configured, the U-SIG may be duplicated. That is, four identical U-SIGs may be included in the 80 MHz PPDU. PPDUs exceeding an 80 MHz bandwidth may include different U-SIGs.

The EHT-SIG of FIG. 10 may include control information for the receiving STA. The EHT-SIG may be transmitted through at least one symbol, and one symbol may have a length of 4 μs. Information related to the number of symbols used for the EHT-SIG may be included in the U-SIG.

The EHT-SIG may include a technical feature of the HE-SIG-B described with reference to FIG. 8 and FIG. 9. For example, the EHT-SIG may include a common field and a user-specific field as in the example of FIG. 8. The common field of the EHT-SIG may be omitted, and the number of user-specific fields may be determined based on the number of users.

As in the example of FIG. 8, the common field of the EHT-SIG and the user-specific field of the EHT-SIG may be individually coded. One user block field included in the user-specific field may include information for two users, but a last user block field included in the user-specific field may include information for one user. That is, one user block field of the EHT-SIG may include up to two user fields. As in the example of FIG. 9, each user field may be related to MU-MIMO allocation, or may be related to non-MU-MIMO allocation.

As in the example of FIG. 8, the common field of the EHT-SIG may include a CRC bit and a tail bit. A length of the CRC bit may be determined as 4 bits. A length of the tail bit may be determined as 6 bits, and may be set to ‘000000’.

As in the example of FIG. 8, the common field of the EHT-SIG may include RU allocation information. The RU allocation information may imply information related to a location of an RU to which a plurality of users (i.e., a plurality of receiving STAs) are allocated. The RU allocation information may be configured in unit of 8 bits (or N bits), as in Table 1.

A mode in which the common field of the EHT-SIG is omitted may be supported. The mode in the common field of the EHT-SIG is omitted may be called a compressed mode. When the compressed mode is used, a plurality of users (i.e., a plurality of receiving STAs) may decode the PPDU (e.g., the data field of the PPDU), based on non-OFDMA. That is, the plurality of users of the EHT PPDU may decode the PPDU (e.g., the data field of the PPDU) received through the same frequency band. Meanwhile, when a non-compressed mode is used, the plurality of users of the EHT PPDU may decode the PPDU (e.g., the data field of the PPDU), based on OFDMA. That is, the plurality of users of the EHT PPDU may receive the PPDU (e.g., the data field of the PPDU) through different frequency bands.

The EHT-SIG may be configured based on various MCS schemes. As described above, information related to an MCS scheme applied to the EHT-SIG may be included in U-SIG. The EHT-SIG may be configured based on a DCM scheme. For example, among N data tones (e.g., 52 data tones) allocated for the EHT-SIG, a first modulation scheme may be applied to half of consecutive tones, and a second modulation scheme may be applied to the remaining half of the consecutive tones. That is, a transmitting STA may use the first modulation scheme to modulate specific control information through a first symbol and allocate it to half of the consecutive tones, and may use the second modulation scheme to modulate the same control information by using a second symbol and allocate it to the remaining half of the consecutive tones. As described above, information (e.g., a 1-bit field) regarding whether the DCM scheme is applied to the EHT-SIG may be included in the U-SIG. An HE-STF of FIG. 10 may be used for improving automatic gain control estimation in a multiple input multiple output (MIMO) environment or an OFDMA environment. An HE-LTF of FIG. 10 may be used for estimating a channel in the MIMO environment or the OFDMA environment.

Information related to a type of STF and/or LTF (information related to a GI applied to LTF is also included) may be included in a SIG-A field and/or SIG-B field or the like of FIG. 10.

A PPDU (e.g., EHT-PPDU) of FIG. 10 may be configured based on the example of FIG. 5 and FIG. 6.

For example, an EHT PPDU transmitted on a 20 MHz band, i.e., a 20 MHz EHT PPDU, may be configured based on the RU of FIG. 5. That is, a location of an RU of EHT-STF, EHT-LTF, and data fields included in the EHT PPDU may be determined as shown in FIG. 5.

An EHT PPDU transmitted on a 40 MHz band, i.e., a 40 MHz EHT PPDU, may be configured based on the RU of FIG. 6. That is, a location of an RU of EHT-STF, EHT-LTF, and data fields included in the EHT PPDU may be determined as shown in FIG. 6.

Since the RU location of FIG. 6 corresponds to 40 MHz, a tone-plan for 80 MHz may be determined when the pattern of FIG. 6 is repeated twice. That is, an 80 MHz EHT PPDU may be transmitted based on a new tone-plan in which not the RU of FIG. 7 but the RU of FIG. 6 is repeated twice.

When the pattern of FIG. 6 is repeated twice, 23 tones (i.e., 11 guard tones+12 guard tones) may be configured in a DC region. That is, a tone-plan for an 80 MHz EHT PPDU allocated based on OFDMA may have 23 DC tones. Unlike this, an 80 MHz EHT PPDU allocated based on non-OFDMA (i.e., a non-OFDMA full bandwidth 80 MHz PPDU) may be configured based on a 996-RU, and may include 5 DC tones, 12 left guard tones, and 11 right guard tones.

A tone-plan for 160/240/320 MHz may be configured in such a manner that the pattern of FIG. 6 is repeated several times.

The PPDU of FIG. 10 may be determined (or identified) as an EHT PPDU based on the following method.

A receiving STA may determine a type of an RX PPDU as the EHT PPDU, based on the following aspect. For example, the RX PPDU may be determined as the EHT PPDU: 1) when a first symbol after an L-LTF signal of the RX PPDU is a BPSK symbol: 2) when RL-SIG in which the L-SIG of the RX PPDU is repeated is detected; and 3) when a result of applying “modulo 3” to a value of a length field of the L-SIG of the RX PPDU is detected as “0”. When the RX PPDU is determined as the EHT PPDU, the receiving STA may detect a type of the EHT PPDU (e.g., an SU/MU/Trigger-based/Extended Range type), based on bit information included in a symbol after the RL-SIG of FIG. 10. In other words, the receiving STA may determine the RX PPDU as the EHT PPDU, based on: 1) a first symbol after an L-LTF signal, which is a BPSK symbol: 2) RL-SIG contiguous to the L-SIG field and identical to L-SIG: 3) L-SIG including a length field in which a result of applying “modulo 3” is set to “0”; and 4) a 3-bit PHY version identifier of the aforementioned U-SIG (e.g., a PHY version identifier having a first value).

For example, the receiving STA may determine the type of the RX PPDU as the EHT PPDU, based on the following aspect. For example, the RX PPDU may be determined as the HE PPDU: 1) when a first symbol after an L-LTF signal is a BPSK symbol: 2) when RL-SIG in which the L-SIG is repeated is detected; and 3) when a result of applying “modulo 3” to a value of a length field of the L-SIG is detected as “1” or “2”.

For example, the receiving STA may determine the type of the RX PPDU as a non-HT, HT, and VHT PPDU, based on the following aspect. For example, the RX PPDU may be determined as the non-HT, HT, and VHT PPDU: 1) when a first symbol after an L-LTF signal is a BPSK symbol; and 2) when RL-SIG in which L-SIG is repeated is not detected. In addition, even if the receiving STA detects that the RL-SIG is repeated, when a result of applying “modulo 3” to the length value of the L-SIG is detected as “0”, the RX PPDU may be determined as the non-HT, HT, and VHT PPDU.

In the following example, a signal represented as a (TX/RX/UL/DL) signal, a (TX/RX/UL/DL) frame, a (TX/RX/UL/DL) packet, a (TX/RX/UL/DL) data unit, (TX/RX/UL/DL) data, or the like may be a signal transmitted/received based on the PPDU of FIG. 10. The PPDU of FIG. 10 may be used to transmit/receive frames of various types. For example, the PPDU of FIG. 10 may be used for a control frame. An example of the control frame may include a request to send (RTS), a clear to send (CTS), a power save-poll (PS-poll), BlockACKReq, BlockAck, a null data packet (NDP) announcement, and a trigger frame. For example, the PPDU of FIG. 10 may be used for a management frame. An example of the management frame may include a beacon frame, a (re-)association request frame, a (re-)association response frame, a probe request frame, and a probe response frame. For example, the PPDU of FIG. 10 may be used for a data frame. For example, the PPDU of FIG. 10 may be used to simultaneously transmit at least two or more of the control frames, the management frame, and the data frame.

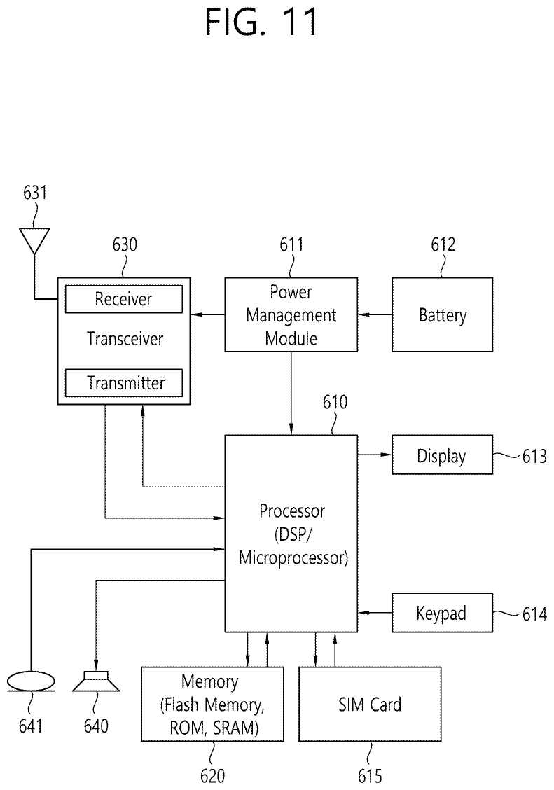

FIG. 11 illustrates an example of a modified transmission device and/or receiving device of the present specification.

Each device/STA of the sub-figure (a)/(b) of FIG. 1 may be modified as shown in FIG. 11. A transceiver 630 of FIG. 11 may be identical to the transceivers 113 and 123 of FIG. 1. The transceiver 630 of FIG. 11 may include a receiver and a transmitter.

A processor 610 of FIG. 11 may be identical to the processors 111 and 121 of FIG. 1. Alternatively, the processor 610 of FIG. 11 may be identical to the processing chips 114 and 124 of FIG. 1.

A memory 620 of FIG. 11 may be identical to the memories 112 and 122 of FIG. 1. Alternatively, the memory 620 of FIG. 11 may be a separate external memory different from the memories 112 and 122 of FIG. 1.

Referring to FIG. 11, a power management module 611 manages power for the processor 610 and/or the transceiver 630. A battery 612 supplies power to the power management module 611. A display 613 outputs a result processed by the processor 610. A keypad 614 receives inputs to be used by the processor 610. The keypad 614 may be displayed on the display 613. A SIM card 615 may be an integrated circuit which is used to securely store an international mobile subscriber identity (IMSI) and its related key, which are used to identify and authenticate subscribers on mobile telephony devices such as mobile phones and computers.

Referring to FIG. 11, a speaker 640 may output a result related to a sound processed by the processor 610. A microphone 641 may receive an input related to a sound to be used by the processor 610.

### 1. Embodiments Applicable to this Specification

In the WLAN 802.11be system, transmission of increased streams is considered by using a wider band than the existing 802.11ax or using more antennas to increase peak throughput. In addition, the present specification also considers a method of aggregating and using various bands/links.

This specification proposes a method for indicating a BW of an Aggregated-PPDU (A-PPDU) in which a HE PPDU and an EHT PPDU are transmitted simultaneously in situations where wide bandwidth, etc. are considered.

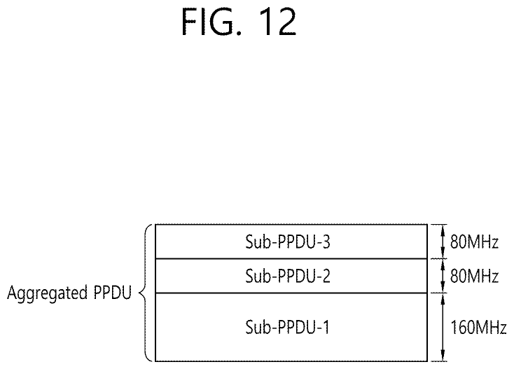

FIG. 12 is a diagram of a representative A-PPDU.

Referring to FIG. 12, each Sub-PPDU may be a HE PPDU/EHT PPDU or a PPDU of a later version of EHT (or EHT Release 2). However, it may be desirable for HE PPDU to be transmitted within Primary 160 MHz. Additionally, it may be desirable for the same type of Sub-PPDU to be transmitted within the primary 160 MHz and secondary 160 MHz. By the SST mechanism, each STA can be assigned to a specific 80 MHz or higher band. In the corresponding band, a Sub-PPDU for each STA may be transmitted or each STA may transmit a Sub-PPDU. For example, by SST (Subchannel Selective Transmission), an STA allocated to Primary 160 MHz transmits and receives HE PPDUs, and an STA allocated to Secondary 160 MHz transmits and receives EHT PPDUs. However, this specification is not limited to situations where SST is applied. Additionally, this specification is described assuming DL A-PPDU transmission.

In DL A-PPDU, HE PPDU may be HE SU/MU PPDU and EHT PPDU may be EHT MU PPDU.

FIG. 10 shows a representative EHT MU PPDU format.

Referring to FIG. 10, U-SIG has a length of 4 us per symbol, and is composed of two symbols, so it has a total length of 8 μs. EHT-SIG has a length of 4 us per symbol. EHT-STF has a length of 4 us, and the symbol section of EHT-LTF may vary depending on the GI (Guard Interval) and LTF size.

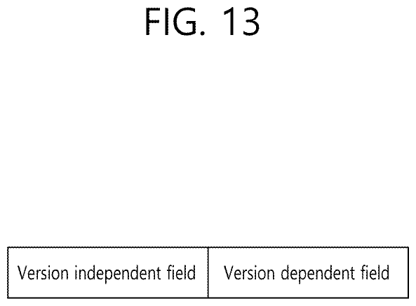

FIG. 13 shows the structure of a U-SIG.

The Universal-Signal (U-SIG) is divided into a version independent field and a version dependent field, as shown in FIG. 13.

The bandwidth of the PPDU can be indicated using the Bandwidth (BW) field, which can be included in the version independent field of the U-SIG. Additionally, in addition to the bandwidth field, the 20 MHz-based preamble puncturing pattern within each 80 MHz can also be indicated. This can help STAs decoding a specific 80 MHz decode EHT-SIG. Therefore, assuming that this information is carried in the U-SIG, the configuration of the U-SIG may change every 80 MHz.

In addition, the version independent field may include a 3-bit version identifier indicating a Wi-Fi version after 802.11be and 802.11be, a 1-bit DL/UL field, BSS color, TXOP duration, etc., and the version dependent field may include information such as PPDU type. In addition, the U-SIG is jointly encoded with two symbols and consists of 52 data tones and 4 pilot tones for each 20 MHz. Also, it is modulated in the same way as HE-SIG-A. That is, it is modulated at BPSK 1/2 code rate. Additionally, EHT-SIG can be divided into common fields and user specific fields and can be encoded with variable Modulation and Coding Scheme (MCS). As in the existing 802.11ax, 1 2 1 2 . . . in units of 20 MHz. It may have a structure (may be composed of other structures, for example, 1 2 3 4 . . . or 1 2 1 2 3 4 3 4 . . . ), may also be configured in units of 80 MHz, and in a bandwidth of 80 MHz or higher, the EHT-SIG may be duplicated in units of 80 MHz or composed of different information.

Basically, UL PPDU transmission can be triggered by a trigger frame, and various PHY information used in the UL PPDU can be transmitted in the trigger frame. Likewise, a trigger frame can be used to transmit DL A-PPDU, and below is the structure of the trigger frame that currently triggers the Trigger Based (TB) PPDU.

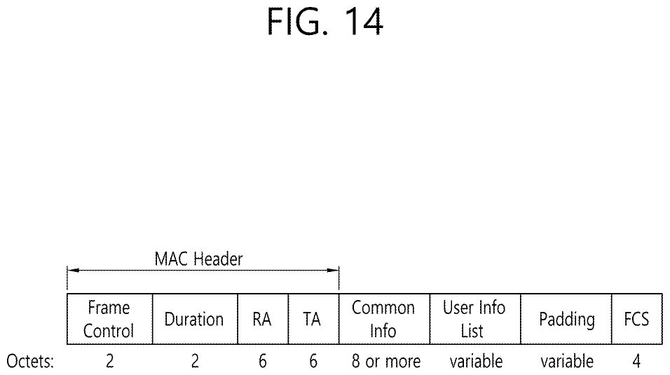

FIG. 14 shows the structure of a trigger frame.

Referring to FIG. 14, the trigger frame includes a MAC header, a Common Info field, a User Info List field, etc.

The AP can use the Trigger frame of FIG. 14 as is to indicate each EHT STA to transmit the transmission information of the DL A-PPDU and then transmit the DL A-PPDU.

### 1.1. Common Info Field

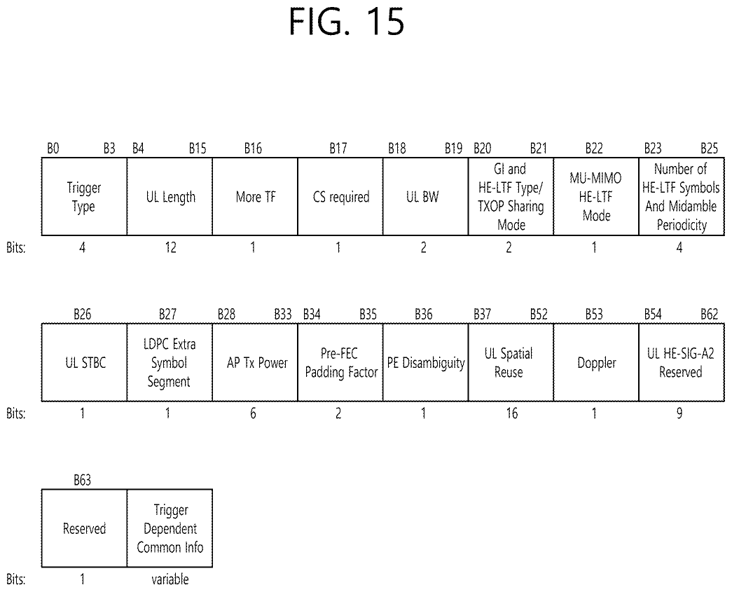

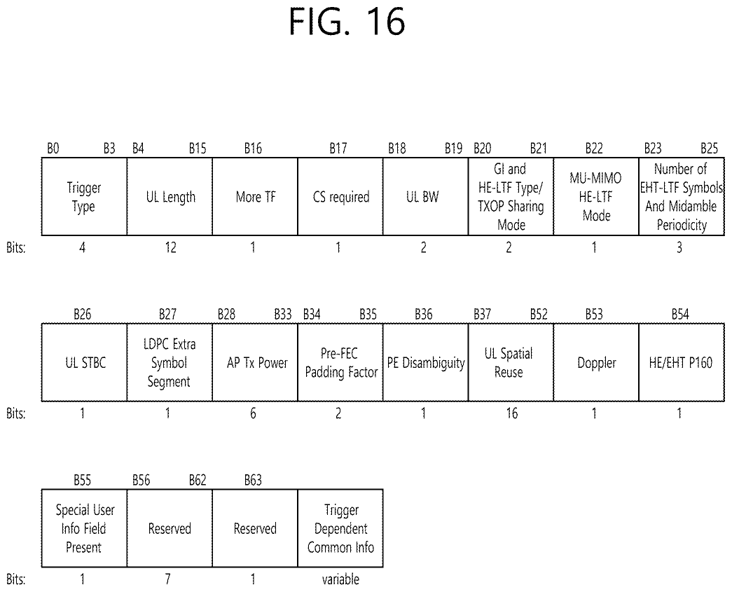

The Common Info field contains common information for each STA and consists of a HE variant field for triggering a HE PPDU and an EHT variant field for triggering an EHT PPDU, as shown in FIGS. 15 and 16, respectively.

FIG. 15 shows the format of an HE variant Common Info field.

FIG. 16 shows the format of an EHT variant Common Info field.

For the EHT STA assigned to the HE PPDU and the EHT STA assigned to the EHT PPDU in situations where information about the DL A-PPDU is indicated, the HE/EHT variant Common Info field of FIGS. 15 and 16 may be used as is, or some subfields may be excluded or reserved, and also, the names of some subfields may be different. Alternatively, the AP can use the EHT variant Common Info field to transmit common information to the EHT STA assigned to the HE PPDU and the EHT STA assigned to the EHT PPDU. In this situation, the EHT variant Common Info field may be used as is, or some subfields may be excluded or reserved, and also, the names of some subfields may be different. Basically, since it is a 320 MHz DL A-PPDU transmission, a 320 MHz Trigger frame can be transmitted.

When both HE/EHT variant Common Info fields are used, the HE variant Common Info field may be transmitted in the Trigger frame transmitted on Primary 160 MHz, and the EHT variant Common Info field may be transmitted in the Trigger frame transmitted on Secondary 160 MHz. This case may be a situation assuming SST. If only the EHT variant Common Info field is transmitted, the Common Info field can be transmitted in the entire 320 MHz Trigger frame (excluding the puncturing part). In this case, SST may or may not be assumed.

Below, each subfield in FIGS. 15 and 16 will be described.

First, the Trigger Type subfield identifies the trigger frame variant and encoding can be defined as follows.

TABLE 3

| Trigger Type | |
|---|---|
| subfield value | Trigger frame variant |
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NFRP) |
| 8-15 | Reserved |

In the Trigger frame indicating information about the DL A-PPDU, Trigger Type can be set to 0. However, since the HE STA can recognize this as a Trigger frame for triggering the HE TB PPDU, it can be set to one of the Reserved values (for example, 8), and the Trigger frame variant can be a DL A-PPDU Trigger, and other Names can be applied. When setting a Reserved value indicating a new Trigger Type, unnecessary subfields among various subfields described later can be removed.

UL Length subfield can be reinterpreted as the length of DL A-PPDU, basically, it can be set to a value corresponding to the length of the HE PPDU in the DL A-PPDU (that is, the remainder 1 or 2 when divided by 3). Alternatively, it can be set to a value corresponding to the length of the EHT PPDU within the DL A-PPDU (i.e., the remainder is 0 when divided by 3). When using a new Trigger frame variant, the UL Length subfield may be changed to the DL Length subfield (a different name may be used).

The More TF subfield may be reserved or removed when using a new Trigger frame variant.

The CS Required subfield may be reserved or removed when using a new Trigger frame variant.

In the case of a trigger frame indicating information about DL A-PPDU, the UL BW subfield can be reinterpreted as a DL BW subfield. This can basically be set to the Bandwidth (BW) of the HE PPDU within the DL A-PPDU. When using a new trigger frame variant, the DL BW subfield may be changed (a different name may be used). When the value of the DL BW subfield is 0, it indicates the BW of the HE PPDU within the DL A-PPDU as 20 MHz. When the value of the DL BW subfield is 1, it indicates the BW of the HE PPDU within the DL A-PPDU as 40 MHz. When the value of the DL BW subfield is 2, it indicates that the BW of the HE PPDU within the DL A-PPDU is 80 MHz. When the value of the DL BW subfield is 3, it indicates the BW of the HE PPDU within the DL A-PPDU as 80+80 MHz or 160 MHz.

The GI And HE/EHT-LTF Type subfield can indicate the HE/EHT-LTF type and Guard Interval (GI) used in DL A-PPDU transmission. Additionally, the value of the GI And HE/EHT-LTF Type subfield can be redefined as follows.
0: 2×HE/EHT-LTF+0.8 us
1: 2×HE/EHT-LTF+1.6 us
2: 4×HE/EHT-LTF+0.8 us
3: 4×HE/EHT-LTF+3.2 us

The MU-MIMO HE-LTF Mode subfield is reserved and can be set to 0 or removed when using the new Trigger frame variant.

By default, the Doppler subfield can be reserved and set to 0. Or it can be removed when using a new Trigger frame variant. In this case, the Number Of EHT-LTF Symbols And Midamble Periodicity subfield may indicate the number of symbols of HE/EHT-LTF used in the DL A-PPDU.

The UL STBC subfield can be reserved, set to 0, or removed when using a new Trigger frame variant.

The LDPC Extra Symbol Segment subfield can indicate the presence or absence of an Low Density Parity Check (LDPC) extra symbol segment in the DL A-PPDU to be transmitted.

The AP Tx Power subfield may be reserved or removed when using a new Trigger frame variant.

The Pre-FEC Padding Factor subfield and PE Disambiguity subfield can be defined as follows.

TABLE 4

| Subfield | Description | Encoding |
|---|---|---|
| Pre-FEC | Indicates the pre-FEC | Set to 0 to indicate a pre-FEC |
| Padding Factor | padding factor | padding factor of 4Set to 1 to |
| | | indicate a pre-FEC padding |
| | | factor of 1 |
| | | Set to 2 to indicate a pre-FEC |
| | | padding factor of 2 |
| | | Set to 3 to indicate a pre-FEC |
| | | padding factor of 3 |
| PE | Indicates PE | When an HE TB PPDU is |
| Disambiguity | disambiguity | solicited, set to 1 if the |
| | | condition in Equationis met; |
| | | other |
| | | Wise it is set to 0 |
| | | When an EHT TB PPDU is |
| | | solicited, set to 1 if the |
| | | condition in Equation is met; |
| | | otherwise it is |
| | | set to 0 |

The UL Spatial Reuse subfield uses only 4 bits and the rest can be reserved or removed when using a new trigger frame variant. Alternatively, entire bits may be reserved or removed when using a new trigger frame variant. When 4 bits are used, the UL Spatial Reuse subfield can be set to one of the values below.

TABLE 5

| Value | Meaning |
|---|---|
| 0 | PSR_DISALLOW |
| 1-12 | Reserved |
| 13 | SR_RESTRICTED |
| 14 | SR_DELAYED |
| 15 | PSR_AND_NON_SRG_OBSS_PD_PROHIBITED |

The HE/EHT P160 subfield is reserved and may always be set to 1 or removed when using a new Trigger frame variant.

The Special User Info Field Present subfield is reserved and may always be set to 0 or removed when using the new Trigger frame variant.

The UL HE-SIG-A2 Reserved subfield may be reserved or removed when using a new Trigger frame variant.

Other Reserved subfields can be reserved as is or removed when using a new Trigger frame variant.

When the Trigger Dependent Common Info subfield is removed or a new Trigger frame variant is used, the Special User Info field below can be defined in the Trigger Dependent Common Info subfield.

### 1.2. Special User Info Field

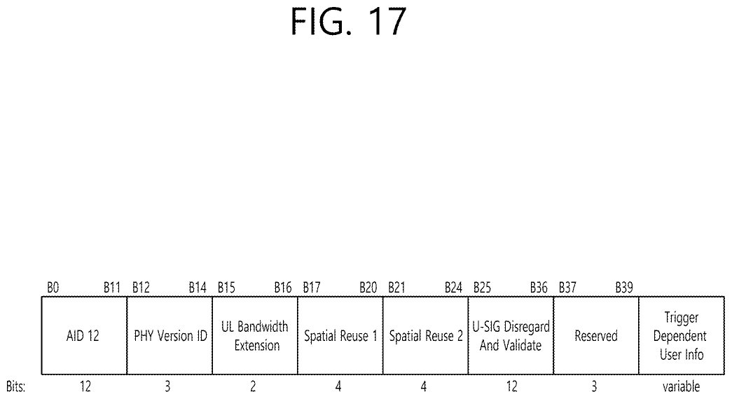

A Special User Info field, which is a Common Info field for an EHT STA allocated to an EHT PPDU, can always be located after the Common Info field (or in the Trigger Dependent Common Info subfield of the Common Info field), and FIG. 17 shows the format of the Special User Info field.

FIG. 17 shows an example of a Special User Info field format.

If the Special User Info field is included in the trigger frame, the Special User Info Field Present subfield of the EHT variant of the Common Info Field is set to 0, otherwise it is set to 1.

The Special User Info field is identified with an AID12 value of 2007 and is optionally present in the trigger frame generated by the EHT AP. However, in the case of a trigger frame indicating information about the DL A-PPDU, the AID12 subfield may be set to 2007 or removed when using a new trigger frame variant.

The UL BW extension subfield can be used as a DL BW extension subfield. When using a new trigger frame variant, the UL BW extension subfield may be changed to the DL BW subfield (a different name may be used). Additionally, the Reserved value can be redefined as follows to indicate the BW of the HE PPDU and EHT PPDU of the DL A-PPDU.

TABLE 6

| UL Bandwidth | UL | Bandwidth for EHT | Bandwidth for HE |
|---|---|---|---|
| Extension (2 bits) | BW | TB PPDU (MHz) | TB PPDU (MHz) |
| 0 | 0 | 20 | 20 |
| 1 | 0 | reserved | 20 |
| 2 | 0 | reserved | 20 |
| 3 | 0 | reserved | 20 |
| 0 | 1 | 40 | 40 |
| 1 | 1 | reserved | 40 |
| 2 | 1 | reserved | 40 |
| 3 | 1 | reserved | 40 |
| 0 | 2 | 80 | 80 |
| 1 | 2 | 160 | 80 |
| 2 | 2 | 320-1 | 80 |
| 3 | 2 | 320-2 | 80 |
| 0 | 3 | 80 | 160 |
| 1 | 3 | 160 | 160 |
| 2 | 3 | 320-1 | 160 |
| 3 | 3 | 320-2 | 160 |

For example, if the UL BW subfield is 3 and the UL BW Extension subfield is set to 0, the BW of the HE PPDU transmitted within the Primary 160 MHz in the DL APPDU may be 160 MHz, and the BW of the EHT PPDU transmitted within the Secondary 160 MHz may be 80 MHz.

Spatial Reuse 1/2 subfield uses only 4 bits, the rest can be reserved or removed when using a new trigger frame variant. Alternatively, entire bits may be reserved or removed when using a new trigger frame variant. When 4 bits are used, the Spatial Reuse 1/2 subfield can be set to one of the values in Table 5 above.

The U-SIG Disregard And Validate subfield may be reserved or removed when using a new Trigger frame variant.

Reserved subfields can be reserved as is or removed when using a new trigger frame variant.

The Trigger Dependent User Info subfield can be removed.

The HE/EHT variant User Info field may be located after the Special User Info field.

### 1.3. HE Variant User Info Field

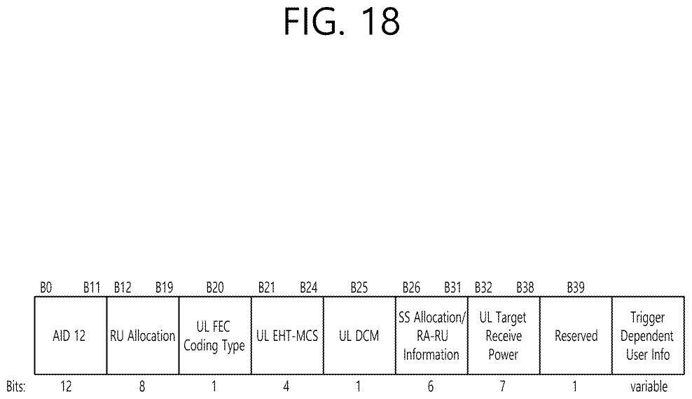

The HE Variant User Info field is a field containing information for the EHT STA allocated to the HE PPDU among DL A-PPDUs, and FIG. 18 shows the format of the HE Variant User Info field.

FIG. 18 shows an example of an HE Variant User Info field format.

In the case of a trigger frame indicating information about DL A-PPDU, the AID12 subfield can be set to 0, 2007, 2045, 2046 or reserved.

The RU Allocation subfield of the HE Variant User Info field along with the UL BW subfield of the Common Info field identifies the size and location of the RU. If the UL BW subfield indicates 20 MHz, 40 MHz, or 80 MHz PPDU, B0 of the RU Allocation subfield is set to 0. If the UL BW subfield indicates 80+80 MHz, or 160 MHz PPDU, B0 in the RU Allocation subfield is set to 0 to indicate that RU allocation applies to the primary 80 MHz channel, and is set to 1 to indicate that RU allocation applies to the secondary 80 MHz channel. The B7-B1 mapping of the RU Allocation subfield for trigger frames other than MU-RTS trigger frames is defined as follows.

TABLE 7

| B7-B1 of the | | | |
|---|---|---|---|
| RU Allocation | | RU | |
| subfield | UL BW subfield | size | RU Index |
| 0-8 | 20 MHz, 40 MHz, 80 MHz, | 26 | RU1 to RU9, respectively |
| | 80 + 80 MHz or 160 MHz | | |
| 9-17 | 40 MHz, 80 MHz, 80 + 80 MHz | | RU10 to RU18, respectively |
| | or 160 MHz | | |
| 18-36 | 80 MHz, 80 + 80 MHz or | | RU19 to RU37, respectively |
| | 160 MHz | | |
| 37-40 | 20 MHz, 40 MHz, 80 MHz, | 52 | RU1 to RU4, respectively |
| | 80 + 80 MHz or 160 MHz | | |
| 41-44 | 40 MHz, 80 MHz, 80 + 80 MHz | | RU5 to RU8, respectively |
| | or 160 MHz | | |
| 45-52 | 80 MHz, 80 + 80 MHz or | | RU9 to RU16, respectively |
| | 160 MHz | | |
| 53, 54 | 20 MHz, 40 MHz, 80 MHz, | 106 | RU1 and RU2, respectively |
| | 80 + 80 MHz or 160 MHz | | |
| 55, 56 | 40 MHz, 80 MHz, 80 + 80 MHz | | RU3 and RU4, respectively |
| | or 160 MHz | | |
| 57-60 | 80 MHz, 80 + 80 MHz or | | RU5 to RU8, respectively |
| | 160 MHz | | |
| 61 | 20 MHz, 40 MHz, 80 MHz, | 242 | RU1 |
| | 80 + 80 MHz or 160 MHz | | |
| 62 | 40 MHz, 80 MHz, 80 + 80 MHz | | RU2 |
| | or 160 MHz | | |
| 63, 64 | 80 MHz, 80 + 80 MHz or | | RU3 and RU4, respectively |
| | 160 MHz | | |
| 65 | 40 MHz, 80 MHz, 80 + 80 MHz | 484 | RU1 |
| | or 160 MHz | | |
| 66 | 80 MHz, 80 + 80 MHz or | | RU2 |
| | 160 MHz | | |
| 67 | 80 MHz, 80 + 80 MHz or | 996 | RU1 |
| | 160 MHz | | |
| 68 | 80 + 80 MHz or 160 MHz | 2 × 996 | RU1 |

NOTE
If the UL BW subfield indicates 80 + 80 MHz or 160 MHz, the description indicates the RU index for the primary 80 MHz channel or secondary 80 MHz channel as indicated by B0 of the RU Allocation subfield.

When the UL BW subfield indicates 40 MHz, the mapping of RU index to RU is defined in ascending order in Table 8.

TABLE 8

| RU type | RU index and subcarrier range | | | | |
|---|---|---|---|---|---|
| 26-tone RU | RU 1 | RU 2 | RU 3 | RU 4 | RU 5 |
| | [−243: −218] | [−217: −192] | [−189: −164] | [−163: −138] | [−136: −111] |
| | RU 6 | RU 7 | RU 8 | RU 9 | |
| | [−109: −84] | [−83: −58] | [−55: −30] | [−29: −4] | |
| | RU 10 | RU 11 | RU 12 | RU 13 | RU 14 |
| | [4: 29] | [30: 55] | [58: 83] | [84: 109] | [111: 136] |
| | RU 15 | RU 16 | RU 17 | RU 18 | |
| | [138: 163] | [164: 189] | [192: 217] | [218: 243] | |
| 52-tone RU | RU 1 | RU 2 | RU 3 | RU 4 | |
| | [−243: −192] | [−189: −138] | [−109: −58] | [−55: −4] | |
| | RU 5 | RU 6 | RU 7 | RU 8 | |
| | [4: 55] | [58: 109] | [138: 189] | [192: 243] | |
| 106-tone RU | RU 1 | RU 2 | RU 3 | RU 4 | |
| | [−243: −138] | [−109: −4] | [4: 109] | [138: 243] | |

| | | |
|---|---|---|
| 242-tone RU | RU 1 | RU 2 |
| | [−244: −3] | [3: 244] |

| | |
|---|---|
| 484-tone RU | RU 1 |
| | [−244: −3, 3: 244] |

The subcarrier index of 0 corresponds to the DC tone. Negative subcarrier indices correspond to subcarries with frequency lower than the DC tone, and positive subcarrier indices correspond to subcarriers with frequency higher than the DC tone.

If the UL BW subfield indicates 80 MHz. 160 MHz or 80+80 MHz, the mapping of RU index to RU is defined in ascending order in Table 9.

TABLE 9

| RU type | RU index and subcarrier range | | | | |
|---|---|---|---|---|---|
| 26-tone RU | RU 1 | RU 2 | RU 3 | RU 4 | RU 5 |
| | [−499: −474] | [−473: −448] | [−445: −420] | [−419: −394] | [−392: −367] |
| | RU 6 | RU 7 | RU 8 | RU 9 | |
| | [−365: −340] | [−339: −314] | [−311: −286] | [−285: −260] | |
| | RU 10 | RU 11 | RU 12 | RU 13 | RU 14 |
| | [−257: −232] | [−231: −206] | [−203: −178] | [−177: −152] | [−150: −125] |
| | RU 15 | RU 16 | RU 17 | RU 18 | RU 19 |
| | [−123: −98] | [−97: −72] | [−69: −44] | [−43: −18] | [−16: −4, 4: 16] |
| | RU 20 | RU 21 | RU 22 | RU 23 | RU 24 |
| | [18: 43] | [44: 69] | [72: 97] | [98: 123] | [125: 150] |
| | RU 25 | RU 26 | RU 27 | RU28 | |
| | [152: 177] | [178: 203] | [206: 231] | [232: 257] | |
| | RU 29 | RU 30 | RU 31 | RU 32 | RU 33 |
| | [260: 285] | [286: 311] | [314: 339] | [340: 365] | [367: 392] |
| | RU 34 | RU 35 | RU 36 | RU37 | |
| | [394: 419] | [420: 445] | [448: 473] | [474: 499] | |
| 52-tone RU | RU 1 | RU 2 | RU 3 | RU 4 | |
| | [−499: −448] | [−445: −394] | [−365: −314] | [−311: −260] | |
| | RU 5 | RU 6 | RU 7 | RU 8 | |
| | [−257: −206] | [−203: −152] | [−123: −72] | [−69: −18] | |
| | RU 9 | RU 10 | RU 11 | RU 12 | |
| | [18: 69] | [72: 123] | [152: 203] | [206: 257] | |
| | RU 13 | RU 14 | RU 15 | RU 16 | |
| | [260: 311] | [314: 365] | [394: 445] | [448: 499] | |
| 106-tone RU | RU 1 | RU 2 | RU 3 | RU 4 | |
| | [−499: −394] | [−365: −260] | [−257: −152] | [−123: −18] | |
| | RU 5 | RU 6 | RU 7 | RU 8 | |
| | [18: 123] | [152: 257] | [260: 365] | [394: 499] | |
| 242-tone RU | RU 1 | RU 2 | RU 3 | RU 4 | |
| | [−500: −259] | 1−258: −17] | [17: 258] | [259: 500] | |

| | | |
|---|---|---|
| 484-tone RU | RU 1 | RU 2 |
| | [−500: −17] | [17: 500] |

| | |
|---|---|
| 996-tone RU | RU 1 |
| | [−500: −3, 3: 500] |

The subcarrier index of 0 corresponds to the DC tone. Negative subcarrier indices correspond to subcarries with frequency lower than the DC tone, and positive subcarrier indices correspond to subcarriers with frequency higher than the DC tone.
RU 19 is the center 26-tone RU.

If the UL BW subfield indicates 160 MHz, or 80+80 MHz. B7-B1 of the RU Allocation subfield is set to 68, and B0 is set to 1 to indicate 2, 996-tone RU. Non-AP STA ignores B0 for 2×996-tone RU indication.

The RU Allocation subfield may indicate the RU location of the EHT STA allocated to the HE PPDU among DL A-PPDUs. B0 can be set as described above depending on the BW indicated in the UL BW subfield (actually indicates the bandwidth of the DL HE PPDU). Regardless of BW, it may always be set based on 160 MHz. That is, RU allocation in Primary 160 MHz can be indicated.

The UL FEC Coding Type subfield can be reinterpreted as the DL FEC Coding Type subfield, and the FEC coding type used for the data part transmitted to the EHT STA assigned to the HE PPDU among the DL A-PPDUs (i.e., indicated by the AID) can be indicated. The UL FEC Coding Type subfield is set to 0 to indicate BCC (Binary Convolutional Coding), and is set to 1 to indicate LDPC. When using a new trigger frame variant, the UL FEC Coding Type subfield can be changed to the DL FEC Coding Type subfield (a different name may be used).

The UL HE-MCS subfield of the HE Variant User Info field indicates the HE-MCS of the solicited HE TB PPDU. UL HE-MCS subfield can be reinterpreted as DL HE-MCS subfield, and the UL HE-MCS subfield may indicate the HE-MCS used in the data part transmitted to the EHT STA assigned to the HE PPDU among the DL A-PPDUs (i.e., indicated by the AID). When using a new trigger frame variant, the UL HE-MCS subfield may be changed to the DL HE-MCS subfield (a different name may be used).

The UL DCM subfield of the HE Variant User Info field indicates DCM (Dual Carrier Modulation) of the solicited HE TB PPDU. UL DCM subfield can be reinterpreted as DL DCM subfield, and the UL DCM subfield may indicate whether to use DCM in the data part transmitted to the EHT STA assigned to the HE PPDU among the DL A-PPDUs (i.e., indicated by the AID). When using a new trigger frame variant, the UL DCM subfield may be changed to the DL HE-MCS subfield (a different name may be used).

The SS Allocation subfield of the HE Variant User Info field indicates the spatial stream of the solicited HE TB PPDU. The SS Allocation subfield indicates the number of spatial streams used in the data part transmitted to the EHT STA allocated to the HE PPDU among the DL A-PPDUs (i.e., indicated by the AID).

The UL Target Receive Power subfield may be reserved or removed when using a new Trigger frame variant.

The Reserved subfield can be reserved and set to 0, or removed when using a new Trigger frame variant. If the PS160 subfield exists in the EHT variant User Info field, it may be desirable to always reserve it and set it to 0.

The Trigger Dependent User Info subfield can be removed.

### 1.4. EHT Variant User Info Field

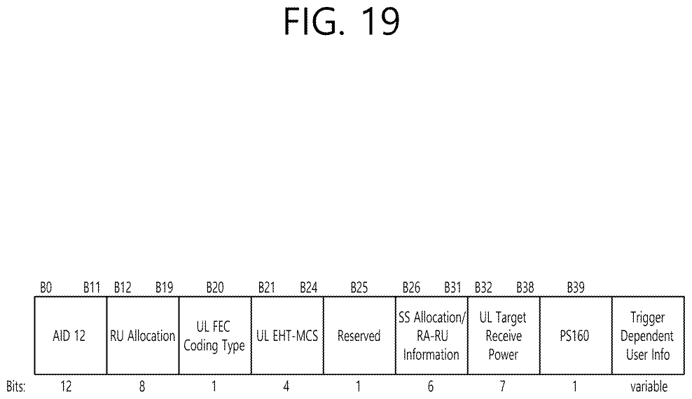

The EHT Variant User Info field is a field containing information for the EHT STA allocated to the EHT PPDU among DL A-PPDUs, and FIG. 19 shows the format of the field.

FIG. 19 shows an example of an EHT Variant User Info field format.

The AID12 subfield of the EHT Variant User Info field can be set in the same way as the HE variant User Info field. That is, in the case of a trigger frame indicating information about DL A-PPDU, the AID12 subfield can be set to 0, 2007, 2045, 2046 or reserved.

The RU Allocation subfield in the EHT Variant User Info field of a trigger frame other than the MU-RTS trigger frame identifies the size and location of the RU/MRU along with the UL BW subfield of the Common Info field, the UL BW Extension subfield of the Special User Info field, and the PS160 subfield of the EHT variant User Info field. The B7-B1 mapping of the RU allocation subfield and the PS160 subfield of the EHT variant User Info field along with the setting of B0 in the RU Allocation subfield are defined in Table 10. Here, the bandwidth is obtained from the combination of the UL BW subfield and the UL Bandwidth Extension subfield, and N is obtained from Table 11 (lookup table for X1 and N) derived from Equation 1.

$$N = 2 \times X 1 + X 0 \qquad [ Equation 1 ]$$

TABLE 10

| | B0 of | B7-B1 of | | | | |
|---|---|---|---|---|---|---|
| | the RU | the RU | | | | PHY RU/ |
| PS160 | Allocation | Allocation | Bandwidth | RU/MRU | | MRU |
| subfield | subfield | subfield | (MHz) | size | RU/MRU index | index |
| 0-3: | | 0-8 | 20, 40, 80, | 26 | RU1 to RU9, | 37 × N + RU |
| 80 MHz subblock where | | | 160, or 320 | | respectively | index |
| the MRU is located_{——} | | 9-17 | 40, 80, 160, | | RU10 to RU18, | |
| | | | or 320) | | respectively | |
| | | 18 | 80, 160, or | | Reserved | |
| | | | 320 | | | |
| | | 19-36 | 80, 160, or | | RU20 to RU37 | |
| | | | 320 | | respectively | |
| | | 37-40 | 20, 40, 80, | 52 | RU1 to RU4, | 16 × N + RU |
| | | | 160, or 320 | | respectively | index |
| | | 41-44 | 40, 80, 160, | | RU5 to RU8, | |
| | | | or 320 | | respectively | |
| | | 45-52 | 80, 160, or | | RU9 to RU16, | |
| | | | 320 | | respectively | |
| | | 53, 54 | 20, 40, 80, | 106 | RU1 and RU2, | 8 × N + RU |
| | | | 160, or 320 | | respectively | index |
| | | 55, 56 | 40, 80, 160, | | RU3 and RU4, | |
| | | | or 320) | | respectively | |
| | | 57-60 | 80, 160, or | | RU5 to RU8, | |
| | | | 320 | | respectively | |
| | | 61 | 20, 40, 80, | 242 | RU1 | 4 × N + RU |
| | | | 160, or 320 | | | index |
| | | 62 | 40, 80, 160, | | RU2 | |
| | | | or 320 | | | |
| | | 63, 64 | 80, 160, or | | RU3 and RU4, | |
| | | | 320 | | respectively | |
| | | 65 | 40, 80, 160, | 484 | RU1 | 2 × N + RU |
| | | | or 320 | | | index |
| | | 66 | 80, 160, or | | RU2 | |
| | | | 320 | | | |
| | | 67 | 80, 160, or | 996 | RU1 | N+ RU |
| | | | 320 | | | index |
| 0-1: | 0 | 68 | 20, 40, 80, | Reserved | Reserved | Reserved |
| 160 MHZ | | | 160, or | | | |
| segment | | | 320_{——}_{——} | | | |
| where the | 1 | | 160 or 320 | 2 × 996 | RU1 | X1 + RU |
| RU is | | | | | | index |
| located | | | | | | |
| 0 | 0 | 69 | 20, 40, 80, | Reserved | Reserved | Reserved |
| 0 | 1 | | 160, or | | | |
| 1 | 0 | | 320_{——}_{——} | | | |
| 1 | 1 | | 320 | 4 × 996 | RU1 | RU1 |
| 0-3: | | 70 | 20,40 | 52 + 26 | MRU1 | 12 × N + |
| 80 MHz subblock where | | | 80, 160, or | Reserved | Reserved | MRU index |
| the MRU is located_{——} | | | 320 | | | |
| | | 71-72 | 20, 40, 80, | 52 + 26 | MRU2 and MRU3, | |
| | | | 160, or 320 | | respectively | |
| | | 73-74 | 40, 80, 160, | 52 + 26 | MRU4 and MRU5, | |
| | | | or 320 | | respectively | |
| | | 75 | | 52 + 26 | MRU6 | |
| | | | 80, 160, or | Reserved | Reserved | |
| | | | 320 | | | |
| | | 76 | 20, 40, 80, | Reserved | Reserved | |
| | | | 160, or | | | |
| | | | 320_{——}_{——} | | | |
| | | 77-80 | 80, 160, or | 52 + 26 | MRU8 to MRU11, | |
| | | | 320 | | respectively | |
| | | 81 | 20, 40, 80, | Reserved | Reserved | |
| | | | 160, or | | | |
| | | | 320_{——}_{——} | | | |
| | | 82 | 20, 40, 80, | 106 + 26 | MRU1 | 8 × N + |
| | | | 160, or 320 | | | MRU index |
| | | 83 | 20,40 | 106 + 26 | MRU2 | |
| | | | 80, 160, or | Reserved | Reserved | |
| | | | 320 | | | |
| | | 84 | 40 | 106 + 26 | MRU3 | |
| | | | 80, 160, or | Reserved | Reserved | |
| | | | 320 | | | |
| | | 85 | 40,80, 160, | 106 + 26 | MRU4 | |
| | | | or 320 | | | |
| | | 86 | 80, 160, or | 106 + 26 | MRU5 | |
| | | | 320 | | | |
| | | 87-88 | 20, 40, 80, | Reserved | Reserved | |
| | | | 160, or | | | |
| | | | 320_{——}_{——} | | | |
| | | 89 | 80, 160, or | 106 + 26 | MRU8 | |
| | | | 320 | | | |
| | | 90-93 | 80, 160, or | 484 + 242 | MRU1 to MRU4, | 4 × N + |
| | | | 320 | | respectively | MRU index |
| 0-1: | 0 | 94, 95 | 160 or 320 | 996 + 484 | MRU1 and MRU2, | 4 × X1 + |
| 160 MHz | | | | | respectively | MRU index |
| segment | 1 | | | | MRU3 and MRU4, | |
| where the | | | | | respectively | |
| MRU is | | | | | | |
| located | | | | | | |
| 0: MRU is | 0 | 96-99 | 160 | 996 + 484 + | MRU1 to MRU4, | MRU |
| located in the | | | | 242 | respectively | index_{——}_{——} |
| primary | 1 | | | | MRU5 to MRU8, | |
| 160 MHz | | | | | respectively | |
| 1 | Any | | 20, 40, 80, | Reserved | Reserved | Reserved |
| | | | 160, or | | | |
| | | | 320_{——}_{——} | | | |
| 0 | 0 | 100-103 | 320 | 2 × 996 + | MRU1 to MRU4, | MRU index |
| | | | | 484 | respectively | |
| 0 | 1 | 100-101 | | | MRU5 and MRU6, | |
| | | | | | respectively | |
| 0 | 1 | 102-103 | 20, 40, 80, | Reserved | Reserved | |
| | | | 160, or | | | |
| | | | 320_{——}_{——} | | | |
| 1 | 0 | 100-101 | 20, 40, 80, | Reserved | Reserved | |
| | | | 160, or | | | |
| | | | 320_{——}_{——} | | | |
| 1 | 0 | 102-103 | 320 | 2 × 996 + | MRU7 and MRU8, | |
| | | | | 484 | respectively | |
| 1 | 1 | 100-103 | | | MRU9 to MRU12, | |
| | | | | | respectively | |
| 0 | 0 | 104 | 320 | 3 × 996 | MRU1 | MRU index |
| 0 | 1 | | | | MRU2 | |
| 1 | 0 | | | | MRU3 | |
| 1 | 1 | | | | MRU4 | |
| 0 | 0 | 105, 106 | 320 | 3 × 996 + | MRU1 and MRU2, | MRU index |
| | | | | 484 | respectively | |
| 0 | 1 | | | | MRU3 and MRU4, | |
| | | | | | respectively | |
| 1 | 0 | | | | MRU5 and MRU6, | |
| | | | | | respectively | |
| 1 | 1 | | | | MRU7 and MRU8, | |
| | | | | | respectively | |
| Any | Any | 107-127 | 20, 40, 80, | Reserved | Reserved | Reserved |
| | | | 160, or | | | |
| | | | 320_{——}_{——} | | | |

NOTE 1-
B0 of the RU Allocation subfield is set to 0 to indicate that the RU/MRU allocation applies to the primary 80 MHz channel and set to 1 to indicate that the RU allocation applies to the secondary 80 MHz channel in the primary 160 MHz. B0 of the RU Allocation subfield is set to 0 to indicate that the RU/MRU allocation applies to the lower 80 MHz in the secondary 160 MHz and is set to 1 to indicate that the RU/MRU allocation applies to upper 80 MHz in the secondary 160 MHz.
NOTE 2-
The PHY MRU index of a 52 + 26-tone MRU is not defined in the case of the MRU index equal to 1, 6, 7, or 12, if the bandwidth indicates 80, 160, or 320 MHz. The PHY MRU index of a 106 + 26-tone MRU is not defined in the case of the MRU index equal to 2, 3, 6, or 7, if the bandwidth indicates 80, 160, or 320 MHz. Refer to 36.3.2.2.2 (Small size MRUs(#2024)) for details.
NOTE 3-
If the size of RU/MRU is smaller than or equal to 2 × 996 tone, then the PS160 subfield is set to 0 to indicate the RU/MRU allocation applies to the primary 160 MHz channel and set to 1 to indicate the RU/MRU allocation applies to the secondary 160 MHz channel. Otherwise, the PS160 subfield is used to indicate the RU/MRU index along with the RU Allocation subfield.

TABLE 11

| Bandwidth | Inputs | | | Outputs | | |
|---|---|---|---|---|---|---|
| (MHZ) | Configuration | PS160 | B0 | X0 | X1 | N |
| 20/40/80 | [P80] | 0 | 0 | 0 | 0 | 0 |
| 160 | [P80 S80] | 0 | 0 | 0 | 0 | 0 |
| | | 0 | 1 | 1 | 0 | 1 |
| | [S80 P80] | 0 | 0 | 1 | 0 | 1 |
| | | 0 | 1 | 0 | 0 | 0 |
| 320 | [P80 S80 S160] | 0 | 0 | 0 | 0 | 0 |
| | | 0 | 1 | 1 | 0 | 1 |
| | | 1 | 0 | 0 | 1 | 2 |
| | | 1 | 1 | 1 | 1 | 3 |
| | [S80 P80 S160] | 0 | 0 | 1 | 0 | 1 |
| | | 0 | 1 | 0 | 0 | 0 |
| | | 1 | 0 | 0 | 1 | 2 |
| | | 1 | 1 | 1 | 1 | 3 |
| | [S160 P80 S80] | 0 | 0 | 0 | 1 | 2 |
| | | 0 | 1 | 1 | 1 | 3 |
| | | 1 | 0 | 0 | 0 | 0 |
| | | 1 | 1 | 1 | 0 | 1 |
| | [S160 S80 P80] | 0 | 0 | 1 | 1 | 3 |
| | | 0 | 1 | 0 | 1 | 2 |
| | | 1 | 0 | 0 | 0 | 0 |
| | | 1 | 1 | 1 | 0 | 1 |

Table 11 above summarizes how to calculate N for various configurations using Equation 1 above. When the bandwidth is 80 MHz or less, PS160, B0, X0, and X1 are set to 0. If the bandwidth is 160 MHz, PS160 and X1 are set to 0, X0 is set to 0 to indicate that RU/MRU allocation applies to the lower 80 MHz block, and X0 is set to 1 to indicate that RU/MRU allocation is applied to the upper 80 MHz block.

For 320 MHz bandwidth, X1 is set to 0 to indicate that RU/MRU allocation applies to the lower 160 MHz segment, and is set to 1 to indicate that the RU/MRU allocation applies to the high 160 MHz segment. X0 is set to 0 to indicate that the RU/MRU allocation applies to the lower 80 MHz subblock, and is set to 1 to indicate that RU/MRU allocation applies to the high 80 MHz subblock. The configuration represents the frequency order of the primary and secondary 80 MHz and 160 MHz channels. The order from left to right represents the order from low to high frequencies. The primary 80 MHz channel is indicated as P80, the secondary 80 MHz channel is indicated as S80, and the secondary 160 MHz channel is indicated as S160.

The value of the PS160 subfield and B0 of the RU Allocation subfield indicate the 80 MHz subblock where the RU/MRU is located for 26-tone RU, 52-tone RU, 106-tone RU, 242-tone RU, 484-tone RU, 996-tone RU, 52+26-tone RU and 106+26-tone RU. The 80 MHz subblock is derived based on the corresponding PHY RU/MRU index column in Table 10 above.

The value of the PS160 subfield indicates the 160 MHz segment where the RU/MRU is located for 2×996-tone RU, 996+484-tone MRU, and 996+484+242-tone MRU.

For 4×996 tones RU, 2×996+484 tones MRU, 3×996 tons MRU, 3×996+484 tons MRU, the RU/MRU index description indicates the RU/MRU index for the 320 MHz channel.

If the bandwidth indicates 20 MHz, the mapping of PHY RU index to RU for Table 12 (Data and pilot subcarrier index for RU in 20 MHz HE PPDU and non-OFDMA 20 MHz HE PPDU) is defined in ascending order.

TABLE 12

| RU type | RU index and subcarrier range | | | | |
|---|---|---|---|---|---|
| 26-tone RU | RU 1 | RU 2 | RU 3 | RU 4 | RU 5 |
| | [−121: −96] | [−95: −70] | [−68: −43] | [−42: −17] | [−16: −4, 4: 16] |
| | RU 6 | RU 7 | RU 8 | RU 9 | |
| | [17: 42] | [43: 68] | [70: 95] | [96: 121] | |
| 52-tone RU | RU 1 | RU 2 | RU 3 | RU 4 | |
| | [−121: −70] | [−68: −17] | [17: 68] | [70: 121] | |

| | | |
|---|---|---|
| 106-tone RU | RU 1 | RU 2 |
| | [−122: −17] | [17: 122] |

| | |
|---|---|
| 242-tone RU | RU 1 |
| | [−122: −2, 2: 122] |

The subcarrier index of 0 corresponds to the DC tone. Negative subcarrier indices correspond to subcarries with frequency lower than the DC tone, and positive subcarrier indices correspond to subcarriers with frequency higher than the DC tone.
RU 5 is the middle 26-tone RU.

If the bandwidth indicates 40 MHz, the mapping of PHY RU indices to RUs is defined in Table 8 above (Data and Pilot Subcarrier Indexes to RUs in 40 MHz HE PPDU and non-OFDMA 40 MHz HE PPDU) in ascending order.

If the bandwidth indicates 80 MHz, the mapping of PHY RU index to RU is defined in Table 13 (Data and Pilot Subcarrier Index for RU in 80 MHz EHT PPDU) in ascending order.

TABLE 13

| RU type | RU index and subcarrier range | | | | |
|---|---|---|---|---|---|
| 26-tone | RU 1 | RU 2 | RU 3 | RU 4 | RU 5 |
| RU | [−499: −474] | [−473: −448] | [−445: −420] | [−419: −394] | [−392: −367] |
| | RU 6 | RU 7 | RU 8 | RU 9 | |
| | [−365: −340] | [−339: −314] | [−311: −286] | [−285: −260] | |
| | RU 10 | RU 11 | RU 12 | RU 13 | RU 14 |
| | [−252: −227] | [−226: −201] | [−198: −173] | [−172: −147] | [−145: −120] |
| | RU 15 | RU 16 | RU 17 | RU 18 | RU 19 |
| | [−118: −93] | [−92: −67] | [−64: −39] | [−38: −13] | [not defined] |
| | RU 20 | RU 21 | RU 22 | RU 23 | RU 24 |
| | [13: 38] | [39: 64] | [67: 92] | [93: 118] | [120: 145] |
| | RU 25 | RU 26 | RU 27 | RU 28 | |
| | [147: 172] | [173: 198] | [201: 226] | [227: 252] | |
| | RU 29 | RU 30 | RU 31 | RU 32 | RU 33 |
| | [260: 285] | [286: 311] | [314: 339] | [340: 365] | [367: 392] |
| | RU 34 | RU 35 | RU 36 | RU 37 | |
| | [394: 419] | [420: 445] | [448: 473] | [474: 499] | |
| 52-tone | RU 1 | RU 2 | RU3 | RU 4 | |
| RU | [−499: −448] | [−445: −394] | [−365: −314] | [−311: −260] | |
| | RU 5 | RU 6 | RU 7 | RU 8 | |
| | [−252: −201] | [−198: −147] | [−118: −67] | [−64: −13] | |
| | RU 9 | RU 10 | RU 11 | RU 12 | |
| | [13: 64] | [67: 118] | [147: 198] | [201: 252] | |
| | RU 13 | RU 14 | RU 15 | RU 16 | |
| | [260: 311] | [314: 365] | [394: 445] | [448: 499] | |
| 106-tone | RU 1 | RU 2 | RU 3 | RU 4 | |
| RU | [−499: −394] | [−365: −260] | [−252: −147] | [−118: −13] | |
| | RU 5 | RU 6 | RU 7 | RU 8 | |
| | [13: 118] | [147: 252] | [260: 365] | [394: 499] | |
| 242-tone | RU 1 | RU 2 | RU 3 | RU 4 | |
| RU | [−500: −259] | [−253: −12] | [12: 253] | [259: 500] | |
| 484-tone | RU 1 | RU 2 | | | |
| RU | [−500: −259, | [12: 253, | | | |
| | −253: −12] | 259: 500] | | | |
| 996-tone | RU 1 | | | | |
| RU | [−500: −3, | | | | |
| | 3: 500] | | | | |

If the bandwidth indicates 160 MHz, the mapping of PHY RU index to RU is defined in Table 14 (Data and Pilot Subcarrier Index to RU in 160 MHz EHT PPDU) in ascending order.

TABLE 14

| RU type | RU index and subcarrier range | | | | |
|---|---|---|---|---|---|
| 26-tone | RU 1 | RU 2 | RU 3 | RU 4 | RU 5 |
| RU | [−1011:−986] | [−985:−960] | [−957:−932] | [−931:−906] | [−904:−879] |
| | RU 6 | RU 7 | RU 8 | RU 9 | |
| | [−877:−852] | [−851:−826] | [−823:−798] | [−797:−772] | |
| | RU 10 | RU 11 | RU 12 | RU 13 | RU 14 |
| | [−764:−739] | [−738:−713] | [−710:−685] | [−684:−659] | [−657:−632] |
| | RU 15 | RU 16 | RU 17 | RU 18 | RU 19 |
| | [−630:−605] | [−604:−579] | [−576:−551] | [−550:−525] | [not defined] |
| | RU 20 | RU 21 | RU 22 | RU 23 | RU 24 |
| | [−499:−474] | [−473:−448] | [−445:−420] | [−419:−394] | [−392:−367] |
| | RU 25 | RU 26 | RU 27 | RU 28 | |
| | [−365:−340] | [−339:−314] | [−311:−286] | [−285:−260] | |
| | RU 29 | RU 30 | RU 31 | RU 32 | RU 33 |
| | [−252:−227] | [−226:−201] | [−198:−173] | [−172:−147] | [−145:−120] |
| | RU 34 | RU 35 | RU 36 | RU 37 | |
| | [−118:−93] | [−92:−67] | [−64:−39] | [−38:−13] | |
| | RU 38 | RU 39 | RU 40 | RU 41 | RU 42 |
| | [13:38] | [39:64] | [67:92] | [93:118] | [120:145] |
| | RU 43 | RU 44 | RU 45 | RU 46 | |
| | [147:172] | [173:198] | [201:226] | [227:252] | |
| | RU 47 | RU 48 | RU 49 | RU 50 | RU 51 |
| | [260:285] | [286:311] | [314:339] | [340:365] | [367:392] |
| | RU 52 | RU 53 | RU 54 | RU 55 | RU 56 |
| | [394:419] | [420:445] | [448:473] | [474:499] | [not defined] |
| | RU 57 | RU 58 | RU 59 | RU 60 | RU 61 |
| | [525:550] | [551:576] | [579:604] | [605:630] | [632:657] |
| | RU 62 | RU 63 | RU 64 | RU 65 | |
| | [659:684] | [685:710] | [713:738] | [739:764] | |
| | RU 66 | RU 67 | RU 68 | RU 69 | RU 70 |
| | [772:797] | [798:823] | [826:851] | [852:877] | [879:904] |
| | RU 71 | RU 72 | RU 73 | RU 74 | |
| | [906:931] | [932:957] | [960:985] | [986:1011] | |
| 52-tone | RU 1 | RU 2 | RU 3 | RU 4 | |
| RU | [−1011:−960] | [−957:−906] | [−877:−826] | [−823:−772] | |
| | RU 5 | RU 6 | RU 7 | RU 8 | |
| | [−764:−713] | [−710:−659] | [−630:−579] | [−576:−525] | |
| | RU 9 | RU 10 | RU 11 | RU 12 | |
| | [−499:−448] | [−445:−394] | [−365:−314] | [−311:−260] | |
| | RU 13 | RU 14 | RU 15 | RU 16 | |
| | [−252:−201] | [−198:−147] | [−118:−67] | [−64:−13] | |
| | RU 17 | RU 18 | RU 19 | RU 20 | |
| | [13:64] | [67:118] | [147:198] | [201:252] | |
| | RU 21 | RU 22 | RU 23 | RU 24 | |
| | [260:311] | [314:365] | [394:445] | [448:499] | |
| | RU 25 | RU 26 | RU 27 | RU 28 | |
| | [525:576] | [579:630] | [659:710] | [713:764] | |
| | RU 29 | RU 30 | RU 31 | RU 32 | |
| | [772:823] | [826:877] | [906:957] | [960:1011] | |
| 106-tone | RU 1 | RU 2 | RU 3 | RU 4 | |
| RU | [−1011:−906] | [−877:−772] | [−764:−659] | [−630:−525] | |
| | RU 5 | RU 6 | RU 7 | RU 8 | |
| | [−499:−394] | [−365:−260] | [−252:−147] | [−118:−13] | |
| | RU 9 | RU 10 | RU 11 | RU 12 | |
| | [13:118] | [147:252] | [260:365] | [394:499] | |
| | RU 13 | RU 14 | RU 15 | RU 16 | |
| | [525:630] | [659:764] | [772:877] | [906:1011] | |
| 242-tone | RU 1 | RU 2 | RU 3 | RU 4 | |
| RU | [−1012:−771] | [−765:−524] | [−500:−259] | [−253:−12] | |
| | RU 5 | RU 6 | RU 7 | RU 8 | |
| | [12:253] | [259:500] | [524:765] | [771:1012] | |
| 484-tone | RU 1 | RU 2 | RU 3 | RU 4 | |
| RU | [−1012:−771, | [−500:−259, | [12:253, | [524:765, | |
| | −765:−524] | −253:−12] | 259:500] | 771:1012] | |
| 996-tone | RU 1 | RU 2 | | | |
| RU | [−1012:−515, | [12:509, | | | |
| | −509:−12] | 515:1012] | | | |
| 2 × 996- | RU 1 | | | | |
| tone RU | [−1012:−515, | | | | |
| | −509:−12, | | | | |
| | 12:509, | | | | |
| | 515:1012] | | | | |

If the bandwidth indicates 320 MHz, the mapping of PHY RU index to RU is defined in Table 15 (Data and Pilot Subcarrier Index to RU in 320 MHz EHT PPDU) in ascending order.

TABLE 15

| RU type | RU index and subcarrier range | | | | |
|---|---|---|---|---|---|
| 26-tone | RU 1 | RU 2 | RU 3 | RU 4 | RU 5 |
| RU | [−2035:−2010] | [−2009:−1984] | [−1981:−1956] | [−1955:−1930] | [−1928:−1903] |
| | RU 6 | RU 7 | RU 8 | RU 9 | |
| | [−1901:−1876] | [−1875:−1850] | [−1847:−1822] | [−1821:−1796] | |
| | RU 10 | RU 11 | RU 12 | RU 13 | RU 14 |
| | [−1788:−1763] | [−1762:−1737] | [−1734:−1709] | [−1708:−1683] | [−1681:−1656] |
| | RU 15 | RU 16 | RU 17 | RU 18 | RU 19 |
| | [−1654:−1629] | [−1628:−1603] | [−1600:−1575] | [−1574:−1549] | [not defined] |
| | RU 20 | RU 21 | RU 22 | RU 23 | RU 24 |
| | [−1523:−1498] | [−1497:−1472] | [−1469:−1444] | [−1443:−1418] | [−1416:−1391] |
| | RU 25 | RU 26 | RU 27 | RU 28 | |
| | [−1389:−1364] | [−1363:−1338] | [−1335:−1310] | [−1309:−1284] | |
| | RU 29 | RU 30 | RU 31 | RU 32 | RU 33 |
| | [−1276:−1251] | [−1250:−1225] | [−1222:−1197] | [−1196:−1171] | [−1169:−1144] |
| | RU 34 | RU 35 | RU 36 | RU 37 | |
| | [−1142:−1117] | [−1116:−1091] | [−1088:−1063] | [−1062:−1037] | |
| | RU 38 | RU 39 | RU 40 | RU 41 | RU 42 |
| | [−1011:−986] | [−985:−960] | [−957:−932] | [−931:−906] | [−904:−879] |
| | RU 43 | RU 44 | RU 45 | RU 46 | |
| | [−877:−852] | [−851:−826] | [−823:−798] | [−797:−772] | |
| | RU 47 | RU 48 | RU 49 | RU 50 | RU 51 |
| | [−764:−739] | [−738:−713] | [−710:−685] | [−684:−659] | [−657:−632] |
| | RU 52 | RU 53 | RU 54 | RU 55 | RU 56 |
| | [−630:−605] | [−604:−579] | [−576:−551] | [−550:−525] | [not defined] |
| | RU 57 | RU 58 | RU 59 | RU 60 | RU 61 |
| | [−499:−474] | [−473:−448] | [−445:−420] | [−419:−394] | [−392:−367] |
| | RU 62 | RU 63 | RU 64 | RU 65 | |
| | [−365:−340] | [−339:−314] | [−311:−286] | [−285:−260] | |
| | RU 66 | RU 67 | RU 68 | RU 69 | RU 70 |
| | [−252:−227] | [−226:−201] | [−198:−173] | [−172:−147] | [−145:−120] |
| | RU 71 | RU 72 | RU 73 | RU 74 | |
| | [−118:−93] | [−92:−67] | [−64:−39] | [−38:−13] | |
| | RU 75 | RU 76 | RU 77 | RU 78 | RU 79 |
| | [13:38] | [39:64] | [67:92] | [93:118] | [120:145] |
| | RU 80 | RU 81 | RU 82 | RU 83 | |
| | [147:172] | [173:198] | [201:226] | [227:252] | |
| | RU 84 | RU 85 | RU 86 | RU 87 | RU 88 |
| | [260:285] | [286:311] | [314:339] | [340:365] | [367:392] |
| | RU 89 | RU 90 | RU 91 | RU 92 | RU 93 |
| | [394:419] | [420:445] | [448:473] | [474:499] | [not defined] |
| | RU 94 | RU 95 | RU 96 | RU 97 | RU 98 |
| | [525:550] | [551:576] | [579:604] | [605:630] | [632:657] |
| 26-tone | RU 99 | RU 100 | RU 101 | RU 102 | |
| RU | [659:684] | [685:710] | [713:738] | [739:764] | |
| | RU 103 | RU 104 | RU 105 | RU 106 | RU 107 |
| | [772:797] | [798:823] | [826:851] | [852:877] | [879:904] |
| | RU 108 | RU 109 | RU 110 | RU 111 | |
| | [906:931] | [932:957] | [960:985] | [986:1011] | |
| | RU 112 | RU 113 | RU 114 | RU 115 | RU 116 |
| | [1037:1062] | [1063:1088] | [1091:1116] | [1117:1142] | [1144:1169] |
| | RU 117 | RU 118 | RU 119 | RU 120 | |
| | [1171:1196] | [1197:1222] | [1225:1250] | [1251:1276] | |
| | RU 121 | RU 122 | RU 123 | RU 124 | RU 125 |
| | [1284:1309] | [1310:1335] | [1338:1363] | [1364:1389] | [1391:1416] |
| | RU 126 | RU 127 | RU 128 | RU 129 | RU 130 |
| | [1418:1443] | [1444:1469] | [1472:1497] | [1498:1523] | [not defined] |
| | RU 131 | RU 132 | RU 133 | RU 134 | RU 135 |
| | [1549:1574] | [1575:1600] | [1603:1628] | [1629:1654] | [1656:1681] |
| | RU 136 | RU 137 | RU 138 | RU 139 | |
| | [1683:1708] | [1709:1734] | [1737:1762] | [1763:1788] | |
| | RU 140 | RU 141 | RU 142 | RU 143 | RU 144 |
| | [1796:1821] | [1822:1847] | [1850:1875] | [1876:1901] | [1903:1928] |
| | RU 145 | RU 146 | RU 147 | RU 148 | |
| | [1930:1955] | [1956:1981] | [1984:2009] | [2010:2035] | |
| 52-tone | RU 1 | RU 2 | RU 3 | RU 4 | |
| RU | [−2035:−1984] | [−1981:−1930] | [−1901:−1850] | [−1847:−1796] | |
| | RU 5 | RU 6 | RU 7 | RU 8 | |
| | [−1788:−1737] | [−1734:−1683] | [−1654:−1603] | [−1600:−1549] | |
| | RU 9 | RU 10 | RU 11 | RU 12 | |
| | [−1523:−1472] | [−1469:−1418] | [−1389:−1338] | [−1335:−1284] | |
| | RU 13 | RU 14 | RU 15 | RU 16 | |
| | [−1276:−1225] | [−1222:−1171] | [−1142:−1091] | [−1088:−1037] | |
| | RU 17 | RU 18 | RU 19 | RU 20 | |
| | [−1011:−960] | [−957:−906] | [−877:−826] | [−823:−772] | |
| | RU 21 | RU 22 | RU 23 | RU 24 | |
| | [−764:−713] | [−710:−659] | [−630:−579] | [−576:−525] | |
| | RU 25 | RU 26 | RU 27 | RU 28 | |
| | [−499:−448] | [−445:−394] | [−365:−314] | [−311:−260] | |
| | RU 29 | RU 30 | RU 31 | RU 32 | |
| | [−252:−201] | [−198:−147] | [−118:−67] | [−64:−13] | |
| | RU 33 | RU 34 | RU 35 | RU 36 | |
| | [13:64] | [67:118] | [147:198] | [201:252] | |
| | RU 37 | RU 38 | RU 39 | RU 40 | |
| | [260:311] | [314:365] | [394:445] | [448:499] | |
| 52-tone | RU 41 | RU 42 | RU 43 | RU 44 | |
| RU | [525:576] | [579:630] | [659:710] | [713:764] | |
| | RU 45 | RU 46 | RU 47 | RU 48 | |
| | [772:823] | [826:877] | [906:957] | [960:1011] | |
| | RU 49 | RU 50 | RU 51 | RU 52 | |
| | [1037:1088] | [1091:1142] | [1171:1222] | [1225:1276] | |
| | RU 53 | RU 54 | RU 55 | RU 56 | |
| | [1284:1335] | [1338:1389] | [1418:1469] | [1472:1523] | |
| | RU 57 | RU 58 | RU 59 | RU 60 | |
| | [1549:1600] | [1603:1654] | [1683:1734] | [1737:1788] | |
| | RU 61 | RU 62 | RU 63 | RU 64 | |
| | [1796:1847] | [1850:1901] | [1930:1981] | [1984:2035] | |
| 106-tone | RU 1 | RU 2 | RU 3 | RU 4 | |
| RU | [−2035:−1930] | [−1901:−1796] | [−1788:−1683] | [−1654:−1549] | |
| | RU 5 | RU 6 | RU 7 | RU 8 | |
| | [−1523:−1418] | [−1389:−1284] | [−1276:−1171] | [−1142:−1037] | |
| | RU 9 | RU 10 | RU 11 | RU 12 | |
| | [−1011:−906] | [−877:−772] | [−764:−659] | [−630:−525] | |
| | RU 13 | RU 14 | RU 15 | RU 16 | |
| | [−499:−394] | [−365:−260] | [−252:−147] | [−118:−13] | |
| | RU 17 | RU 18 | RU 19 | RU 20 | |
| | [13:118] | [147:252] | [260:365] | [394:499] | |
| | RU 21 | RU 22 | RU 23 | RU 24 | |
| | [525:630] | [659:764] | [772:877] | [906:1011] | |
| | RU 25 | RU 26 | RU 27 | RU 28 | |
| | [1037:1142] | [1171:1276] | [1284:1389] | [1418:1523] | |
| | RU 29 | RU 30 | RU 31 | RU 32 | |
| | [1549:1654] | [1683:1788] | [1796:1901] | [1930:2035] | |
| 242-tone | RU 1 | RU 2 | RU 3 | RU 4 | |
| RU | [−2036:−1795] | [−1789:−1548] | [−1524:−1283] | [−1277:−1036] | |
| | RU 5 | RU 6 | RU 7 | RU 8 | |
| | [−1012:−771] | [−765:−524] | [−500:−259] | [−253:−12] | |
| | RU 9 | RU 10 | RU 11 | RU 12 | |
| | [12:253] | [259:500] | [524:765] | [771:1012] | |
| | RU 13 | RU 14 | RU 15 | RU 16 | |
| | [1036:1277] | [1283:1524] | [1548:1789] | [1795:2036] | |
| 484-tone | RU 1 | RU 2 | RU 3 | RU 4 | |
| RU | [−2036:−1795, | [−1524:−1283, | [−1012:−771, | [−500:−259, | |
| | −1789:−1548] | −1277:−1036] | −765:−524] | −253:−12] | |
| | RU 5 | RU 6 | RU 7 | RU 8 | |
| | [12:253, | [524:765, | [1036:1277, | [1548: 1789, | |
| | 259:500] | 771:1012] | 1283:1524] | 1795: 2036] | |
| 996-tone | RU 1 | RU 2 | RU 3 | RU 4 | |
| RU | [−2036:−1539, | [−1012:−515, | [12:509, | [1036:1533, | |
| | −1533:−1036] | −509:−12] | 515:1012] | 1539:2036] | |
| 2 × 996- | RU 1 | RU 2 | | | |
| tone RU | [−2036:−1539, | [12:509, | | | |
| | −1533:−1036, | 515:1012, | | | |
| | −1012:−515, | 1036:1533, | | | |
| | −509:−12] | 1539:2036] | | | |
| 4 × 996- | RU 1 | | | | |
| tone RU | [−2036:−1539, | | | | |
| | −1533:−1036, | | | | |
| | −1012:−515, | | | | |
| | −509:−12, | | | | |
| | 12:509, | | | | |
| | 515:1012, | | | | |
| | 1036:1533, | | | | |
| | 1539:2036] | | | | |

If the bandwidth indicates 20 MHz, the mapping of PHY MRU index to MRU is defined in Table 16 (Index for small MRU in OFDMA 20 MHz EHT PPDU) in ascending order.

TABLE 16

| | MRU | |
|---|---|---|
| MRU type | index | MRU combination |
| 52 + 26-tone | MRU 1 | 52-tone RU 2 + 26-tone RU 2 |
| MRU | MRU 2 | 52-tone RU 2 + 26-tone RU 5 |
| | MRU 3 | 52-tone RU 3 + 26-tone RU 8 |
| 106 + 26-tone | MRU 1 | 106-tone RU 1 + 26-tone RU 5 |
| MRU | MRU 2 | 106-tone RU 2 + 26-tone RU 5 |

If the bandwidth indicates 40 MHz, the mapping of PHY MRU index to MRU is defined in Table 17 (Index for small MRU in OFDMA 40 MHz EHT PPDU) in ascending order.

TABLE 17

| | MRU | |
|---|---|---|
| MRU type | index | MRU combination |
| 52 + 26-tone | MRU 1 | 52-tone RU 2 + 26-tone RU 2 |
| MRU | MRU 2 | 52-tone RU 2 + 26-tone RU 5 |
| | MRU 3 | 52-tone RU 3 + 26-tone RU 8 |
| | MRU 4 | 52-tone RU 6 + 26-tone RU 11 |
| | MRU 5 | 52-tone RU 6 + 26-tone RU 14 |
| | MRU 6 | 52-tone RU 7 + 26-tone RU 17 |
| 106 + 26-tone | MRU 1 | 106-tone RU 1 + 26-tone RU 5 |
| MRU | MRU 2 | 106-tone RU 2 + 26-tone RU 5 |
| | MRU 3 | 106-tone RU 3 + 26-tone RU 14 |
| | MRU 4 | 106-tone RU 4 + 26-tone RU 14 |

If the bandwidth represents 80 MHz, the mapping of PHY MRU indices to MRUs is defined in Table 18 (index for small MRU in OFDMA 80 MHz EHT PPDU) and Table 19 (index for large MRU in OFDMA 80 MHz EHT PPDU and non-OFDMA 80 MHz EHT PPDU) in ascending order.

TABLE 18

| | MRU | |
|---|---|---|
| MRU type | index | MRU combination |
| 52 + 26-tone | MRU 1 | Not defined |
| MRU | MRU 2 | 52-tone RU 2 + 26-tone RU 5 |
| | MRU 3 | 52-tone RU 3 + 26-tone RU 8 |
| | MRU 4 | 52-tone RU 6 + 26-tone RU 11 |
| | MRU 5 | 52-tone RU 6 + 26-tone RU 14 |
| | MRU 6 | Not defined |
| | MRU 7 | Not defined |
| | MRU 8 | 52-tone RU 10 + 26-tone RU 24 |
| | MRU 9 | 52-tone RU 11 + 26-tone RU 27 |
| | MRU 10 | 52-tone RU 14 + 26-tone RU 30 |
| | MRU 11 | 52-tone RU 14 + 26-tone RU 33 |
| | MRU 12 | Not defined |
| 106 + 26-tone | MRU 1 | 106-tone RU 1 + 26-tone RU 5 |
| MRU | MRU 2 | Not defined |
| | MRU 3 | Not defined |
| | MRU 4 | 106-tone RU 4 + 26-tone RU 14 |
| | MRU 5 | 106-tone RU 5 + 26-tone RU 24 |
| | MRU 6 | Not defined |
| | MRU 7 | Not defined |
| | MRU 8 | 106-tone RU 8 + 26-tone RU 33 |

TABLE 19

| | MRU | |
|---|---|---|
| MRU type | index | Combinations |
| 484 + 242-tone | MRU 1 | 484-tone RU 2 + 242-tone RU 2; [(gap-242- |
| MRU | | tone RU) − 242-tone RU − 484-tone RU] |
| | MRU 2 | 484-tone RU 2 + 242-tone RU 1; [242-tone |
| | | RU − (gap-242-tone RU) − 484-tone RU] |
| | MRU 3 | 484-tone RU 1 + 242-tone RU 4; [484-tone |
| | | RU − (gap-242-tone RU) − 242-tone RU] |
| | MRU 4 | 484-tone RU 1 + 242-tone RU 3; [484-tone |
| | | RU − 242-tone RU − (gap-242-tone RU)] |

NOTE 1
“Gap-242/484/996-tone RU” is not part of a MRU and is used to indicate the size of a gap between RUs that form the MRU.
NOTE 2
In non-OFDMA transmission, “gap-242/484/996-tone RU” indicates that one or more 20 MHz subchannels corresponding to “gap-242/484/996-tone RU” are punctured and is to help indicate the frequency order of the MRU in an 80/160/320 MHz PPDU.
NOTE 3
In OFDMA transmission, “gap-242/484/996-tone RU” indicates that one or more 20 MHz subchannels corresponding to “gap-242/484/996-tone RU” are punctured or unassigned or used for data transmission by assigning one or multiple RU/MRU and is to help indicate the frequency order of the MRU within an 80/160/240/320 MHz subband.

If the bandwidth represents 160 MHz, the mapping of PHY MRU indices to MRUs is defined in Table 20 (index for small MRU in OFDMA 160 MHz EHT PPDU) and Table 21 (index for large MRU in OFDMA 160 MHz EHT PPDU and non-OFDMA 160 MHz EHT PPDU) in ascending order.

TABLE 20

| | MRU | |
|---|---|---|
| MRU type | index | MRU combination |
| 52 + 26-tone | MRU 1 | Not defined |
| MRU | MRU 2 | 52-tone RU 2 + 26-tone RU 5 |
| | MRU 3 | 52-tone RU 3 + 26-tone RU 8 |
| | MRU 4 | 52-tone RU 6 + 26-tone RU 11 |
| | MRU 5 | 52-tone RU 6 + 26-tone RU 14 |
| | MRU 6 | Not defined |
| | MRU 7 | Not defined |
| | MRU 8 | 52-tone RU 10 + 26-tone RU 24 |
| | MRU 9 | 52-tone RU 11 + 26-tone RU 27 |
| | MRU 10 | 52-tone RU 14 + 26-tone RU 30 |
| | MRU 11 | 52-tone RU 14 + 26-tone RU 33 |
| | MRU 12 | Not defined |
| | MRU 13 | Not defined |
| | MRU 14 | 52-tone RU 18 + 26-tone RU 42 |
| | MRU 15 | 52-tone RU 19 + 26-tone RU 45 |
| | MRU 16 | 52-tone RU 22 + 26-tone RU 48 |
| | MRU 17 | 52-tone RU 22 + 26-tone RU 51 |
| | MRU 18 | Not defined |
| | MRU 19 | Not defined |
| | MRU 20 | 52-tone RU 26 + 26-tone RU 61 |
| | MRU 21 | 52-tone RU 27 + 26-tone RU 64 |
| | MRU 22 | 52-tone RU 30 + 26-tone RU 67 |
| | MRU 23 | 52-tone RU 30 + 26-tone RU 70 |
| | MRU 24 | Not defined |
| 106 + 26-tone | MRU 1 | 106-tone RU 1 + 26-tone RU 5 |
| MRU | MRU 2 | Not defined |
| | MRU 3 | Not defined |
| | MRU 4 | 106-tone RU 4 + 26-tone RU 14 |
| | MRU 5 | 106-tone RU 5 + 26-tone RU 24 |
| | MRU 6 | Not defined |
| | MRU 7 | Not defined |
| | MRU 8 | 106-tone RU 8 + 26-tone RU 33 |
| | MRU 9 | 106-tone RU 9 + 26-tone RU 42 |
| | MRU 10 | Not defined |
| | MRU 11 | Not defined |
| | MRU 12 | 106-tone RU 12 + 26-tone RU 51 |
| | MRU 13 | 106-tone RU 13 + 26-tone RU 61 |
| | MRU 14 | Not defined |
| | MRU 15 | Not defined |
| | MRU 16 | 106-tone RU 16 + 26-tone RU 70 |

TABLE 21

| | MRU | |
|---|---|---|
| MRU type | index | Combinations |
| 484 + 242-tone | MRU 1 | 484-tone RU 2 + 242-tone RU 2; [(gap-242-tone RU) − |
| MRU | | 242-tone RU − 484-tone RU] in lower 80 MHz channel |
| | MRU 2 | 484-tone RU 2 + 242-tone RU 1; [242-tone RU − (gap-242- |
| | | tone RU) − 484-tone RU] in lower 80 MHz channel |
| | MRU 3 | 484-tone RU 1 + 242-tone RU 4; [484-tone RU − (gap-242- |
| | | tone RU) − 242-tone RU] in lower 80 MHz channel |
| | MRU 4 | 484-tone RU 1 + 242-tone RU 3; [484-tone RU − 242-tone |
| | | RU − (gap-242-tone RU)] in lower 80 MHz channel |
| | MRU 5 | 484-tone RU 4 + 242-tone RU 6; [(gap-242-tone RU) − |
| | | 242-tone RU − 484-tone RU] in upper 80 MHz channel |
| | MRU 6 | 484-tone RU 4 + 242-tone RU 5; [242-tone RU − (gap-242- |
| | | tone RU) − 484-tone RU] in upper 80 MHz channel |
| | MRU 7 | 484-tone RU 3 + 242-tone RU 8; [484-tone RU − (gap-242- |
| | | tone RU) − 242-tone RU] in upper 80 MHz channel |
| | MRU 8 | 484-tone RU 3 + 242-tone RU 7; [484-tone RU − 242-tone |
| | | RU − (gap-242-tone RU)] in upper 80 MHz channel |
| 996 + 484-tone | MRU 1 | 996-tone RU 2 + 484-tone RU 2; [(gap-484-tone RU) − |
| MRU | | 484-tone RU − 996-tone RU] |
| | MRU 2 | 996-tone RU 2 + 484-tone RU 1; [484-tone RU − (gap-484- |
| | | tone RU) − 996-tone RU] |
| | MRU 3 | 996-tone RU 1 + 484-tone RU 4; [996-tone RU − (gap-484- |
| | | tone RU) − 484-tone RU] |
| | MRU 4 | 996-tone RU 1 + 484-tone RU 3; [996-tone RU − 484-tone |
| | | RU − (gap-484-tone RU)] |
| 996 + 484 + | MRU 1 | 996-tone RU 2 + 484-tone RU 2 + 242-tone RU 2; [(gap-242- |
| 242-tone MRU | | tone RU) − 242-tone − RU 484-tone RU − 996-tone RU] |
| (only for non- | MRU 2 | 996-tone RU 2 + 484-tone RU 2 + 242-tone RU 1; [242-tone |
| OFDMA) | | RU − (gap-242-tone RU) − 484-tone RU − 996-tone RU] |
| | MRU 3 | 996-tone RU 2 + 484-tone RU 1 + 242-tone RU 4; [484-tone |
| | | RU − (gap-242-tone RU) − 242-tone RU − 996-tone RU] |
| | MRU 4 | 996-tone RU 2 + 484-tone RU 1 + 242-tone RU 3; [484-tone |
| | | RU − 242-tone RU − (gap-242-tone RU) − 996-tone RU] |
| | MRU 5 | 996-tone RU 1 + 484-tone RU 4 + 242-tone RU 6; [996-tone |
| | | RU − (gap-242-tone RU) − 242-tone RU − 484-tone RU] |
| | MRU 6 | 996-tone RU 1 + 484-tone RU 4 + 242-tone RU 5; [996-tone |
| | | RU − 242-tone RU − (gap-242-tone RU) − 484-tone RU] |
| | MRU 7 | 996-tone RU 1 + 484-tone RU 3 + 242-tone RU 8; [996-tone |
| | | RU − 484-tone RU − (gap-242-tone RU) − 242-tone RU] |
| | MRU 8 | 996-tone RU 1 + 484-tone RU 3 + 242-tone RU 7; [996-tone |
| | | RU − 484-tone RU − 242-tone RU − (gap-242-tone RU)] |

NOTE 1
“Gap-242/484/996-tone RU” is not part of a MRU and is used to indicate the size of a gap between RUs that form the MRU.
NOTE 2
In non-OFDMA transmission, “gap-242/484/996-tone RU” indicates that one or more 20 MHz subchannels corresponding to “gap-242/484/996-tone RU” are punctured and is to help indicate the frequency order of the MRU in an 80/160/320 MHz PPDU.
NOTE 3
In OFDMA transmission, “gap-242/484/996-tone RU” indicates that one or more 20 MHz subchannels corresponding to “gap-242/484/996-tone RU” are punctured or unassigned or used for data transmission by assigning one or multiple RU/MRU and is to help indicate the frequency order of the MRU within an 80/160/240/320 MHz subband.

If the bandwidth represents 320 MHz, the mapping of PHY MRU indices to MRUs is defined in Table 22 (index for small MRU in OFDMA 320 MHz EHT PPDU) and Table 23 (index for large MRU in OFDMA 320 MHz EHT PPDU and non-OFDMA 320 MHz EHT PPDU) in ascending order.

TABLE 22

| | MRU | |
|---|---|---|
| MRU type | index | MRU combination |
| 52 + 26-tone | MRU 1 | Not defined |
| MRU | MRU 2 | 52-tone RU 2 + 26-tone RU 5 |
| | MRU 3 | 52-tone RU 3 + 26-tone RU 8 |
| | MRU 4 | 52-tone RU 6 + 26-tone RU 11 |
| | MRU 5 | 52-tone RU 6 + 26-tone RU 14 |
| | MRU 6 | Not defined |
| | MRU 7 | Not defined |
| | MRU 8 | 52-tone RU 10 + 26-tone RU 24 |
| | MRU 9 | 52-tone RU 11 + 26-tone RU 27 |
| | MRU 10 | 52-tone RU 14 + 26-tone RU 30 |
| | MRU 11 | 52-tone RU 14 + 26-tone RU 33 |
| | MRU 12 | Not defined |
| | MRU 13 | Not defined |
| | MRU 14 | 52-tone RU 18 + 26-tone RU 42 |
| | MRU 15 | 52-tone RU 19 + 26-tone RU 45 |
| | MRU 16 | 52-tone RU 22 + 26-tone RU 48 |
| | MRU 17 | 52-tone RU 22 + 26-tone RU 51 |
| | MRU 18 | Not defined |
| | MRU 19 | Not defined |
| | MRU 20 | 52-tone RU 26 + 26-tone RU 61 |
| | MRU 21 | 52-tone RU 27 + 26-tone RU 64 |
| | MRU 22 | 52-tone RU 30 + 26-tone RU 67 |
| | MRU 23 | 52-tone RU 30 + 26-tone RU 70 |
| | MRU 24 | Not defined |
| | MRU 25 | Not defined |
| | MRU 26 | 52-tone RU 34 + 26-tone RU 79 |
| | MRU 27 | (52-tone RU 35 + 26-tone RU 82 |
| | MRU 28 | 52-tone RU 38 + 26-tone RU 85 |
| | MRU 29 | 52-tone RU 38 + 26-tone RU 88 |
| | MRU 30 | Not defined |
| | MRU 31 | Not defined |
| | MRU 32 | 52-tone RU 42 + 26-tone RU 98 |
| | MRU 33 | 52-tone RU 43 + 26-tone RU 101 |
| | MRU 34 | 52-tone RU 46 + 26-tone RU 104 |
| | MRU 35 | 52-tone RU 46 + 26-tone RU 107 |
| | MRU 36 | Not defined |
| | MRU 37 | Not defined |
| | MRU 38 | 52-tone RU 50 + 26-tone RU 116 |
| | MRU 39 | 52-tone RU 51 + 26-tone RU 119 |
| | MRU 40 | 52-tone RU 54 + 26-tone RU 122 |
| | MRU 41 | 52-tone RU 54 + 26-tone RU 125 |
| | MRU 42 | Not defined |
| | MRU 43 | (Not defined |
| | MRU 44 | 52-tone RU 58 + 26-tone RU 135 |
| | MRU 45 | 52-tone RU 59 + 26-tone RU 138 |
| | MRU 46 | 52-tone RU 62 + 26-tone RU 141 |
| | MRU 47 | 52-tone RU 62 + 26-tone RU 144 |
| | MRU 48 | Not defined |
| 106 + 26-tone | MRU 1 | 106-tone RU 1 + 26-tone RU 5 |
| MRU | MRU 2 | Not defined |
| | MRU 3 | Not defined |
| | MRU 4 | 106-tone RU 4 + 26-tone RU 14 |
| | MRU 5 | 106-tone RU 5 + 26-tone RU 24 |
| | MRU 6 | Not defined |
| | MRU 7 | Not defined |
| | MRU 8 | 106-tone RU 8 + 26-tone RU 33 |
| | MRU 9 | 106-tone RU 9 + 26-tone RU 42 |
| | MRU 10 | Not defined |
| | MRU 11 | Not defined |
| | MRU 12 | 106-tone RU 12 + 26-tone RU 51 |
| | MRU 13 | 106-tone RU 13 + 26-tone RU 61 |
| | MRU 14 | Not defined |
| | MRU 15 | Not defined |
| | MRU 16 | 106-tone RU 16 + 26-tone RU 70 |
| | MRU 17 | 106-tone RU 17 + 26-tone RU 79 |
| | MRU 18 | Not defined |
| | MRU 19 | Not defined |
| | MRU 20 | 106-tone RU 20 + 26-tone RU 88 |
| | MRU 21 | 106-tone RU 21 + 26-tone RU 98 |
| | MRU 22 | Not defined |
| | MRU 23 | Not defined |
| | MRU 24 | 106-tone RU 24 + 26-tone RU 107 |
| | MRU 25 | 106-tone RU 25 + 26-tone RU 116 |
| | MRU 26 | Not defined |
| | MRU 27 | Not defined |
| | MRU 28 | 106-tone RU 28 + 26-tone RU 125 |
| | MRU 29 | 106-tone RU 29 + 26-tone RU 135 |
| | MRU 30 | Not defined |
| | MRU 31 | Not defined |
| | MRU 32 | 106-tone RU 32 + 26-tone RU 144 |

TABLE 23

| | MRU | |
|---|---|---|
| MRU type | index | Combinations |
| 484 + 242-tone | MRU 1 | 484-tone RU 2 + 242-tone RU 2; [(gap-242-tone RU) − 242-tone RU − |
| MRU | | 484-tone RU] in lower 80 MHz channel in lower 160 MHz |
| | MRU 2 | 484-tone RU 2 + 242-tone RU 1; [242-tone RU − (gap-242-tone RU) − |
| | | 484-tone RU] in lower 80 MHz channel in lower 160 MHz |
| | MRU 3 | 484-tone RU 1 + 242-tone RU 4; [484-tone RU − (gap-242-tone RU) − |
| | | 242-tone RU] in lower 80 MHz channel in lower 160 MHz |
| | MRU 4 | 484-tone RU 1 + 242-tone RU 3; [484-tone RU − 242-tone RU − |
| | | (gap-242-tone RU)] in lower 80 MHz channel in lower 160 MHz |
| | MRU 5 | 484-tone RU 4 + 242-tone RU 6; [(gap-242-tone RU) − 242-tone RU − |
| | | 484-tone RU] in upper 80 MHz channel in lower 160 MHz |
| | MRU 6 | 484-tone RU 4 + 242-tone RU 5; [242-tone RU − (gap-242-tone RU) − |
| | | 484-tone RU] in upper 80 MHz channel in lower 160 MHz |
| | MRU 7 | 484-tone RU 3 + 242-tone RU 8; [484-tone RU − (gap-242-tone RU) − |
| | | 242-tone RU] in upper 80 MHz channel in lower 160 MHz |
| | MRU 8 | 484-tone RU 3 + 242-tone RU 7; [484-tone RU − 242-tone RU − |
| | | (gap-242-tone RU)] in upper 80 MHz channel in lower 160 MHz |
| | MRU 9 | 484-tone RU 6 + 242-tone RU 10; [(gap-242-tone RU) − 242-tone RU − |
| | | 484-tone RU] in lower 80 MHz channel in upper 160 MHz |
| | MRU 10 | 484-tone RU 6 + 242-tone RU 9; [242-tone RU − (gap-242-tone RU) − |
| | | 484-tone RU] in lower 80 MHz channel in upper 160 MHz |
| | MRU 11 | 484-tone RU 5 + 242-tone RU 12; [484-tone RU − (gap-242-tone RU) − |
| | | 242-tone RU] in lower 80 MHz channel in upper 160 MHz |
| | MRU 12 | 484-tone RU 5 + 242-tone RU 11; [484-tone RU − 242-tone RU − (gap- |
| | | 242-tone RU)] in lower 80 MHz channel in upper 160 MHz |
| | MRU 13 | 484-tone RU 8 + 242-tone RU 14; [(gap-242-tone RU) − 242-tone RU − |
| | | 484-tone RU] in upper 80 MHz channel in upper 160 MHz |
| | MRU 14 | 484-tone RU 8 + 242-tone RU 13; [242-tone RU − (gap-242-tone RU) − |
| | | 484-tone RU] in upper 80 MHz channel in upper 160 MHz |
| | MRU 15 | 484-tone RU 7 + 242-tone RU 16; [484-tone RU − (gap-242-tone RU) − |
| | | 242-tone RU] in upper 80 MHz channel in upper 160 MHz |
| | MRU 16 | 484-tone RU 7 + 242-tone RU 15; [484-tone RU − 242-tone RU − (gap- |
| | | 242-tone RU)] in upper 80 MHz channel in upper 160 MHz |
| 996 + 484-tone | MRU 1 | 996-tone RU 2 + 484-tone RU 2; [(gap-484-tone RU) − 484-tone RU] − |
| MRU | | 996-tone RU] in lower 160 MHz |
| | MRU 2 | 996-tone RU 2 + 484-tone RU 1; [484-tone RU − (gap-484-tone RU) − |
| | | 996-tone RU] in lower 160 MHz |
| | MRU 3 | 996-tone RU 1 + 484-tone RU 4; [996-tone RU − (gap-484-tone RU) − |
| | | 484-tone RU] in lower 160 MHz |
| | MRU 4 | 996-tone RU 1 + 484-tone RU 3; [996-tone RU − 484-tone RU − |
| | | (gap-484-tone RU)] in lower 160 MHz |
| | MRU 5 | 996-tone RU 4 + 484-tone RU 6; [(gap-484-tone RU) − 484-tone RU − |
| | | 996-tone RU] in upper 160 MHz |
| | MRU 6 | 996-tone RU 4 + 484-tone RU 5; [484-tone RU − (gap-484-tone RU) − |
| | | 996-tone RU] in upper 160 MHz |
| | MRU 7 | 996-tone RU 3 + 484-tone RU 8; [996-tone RU − (gap-484-tone RU) − |
| | | 484-tone RU] in upper 160 MHz |
| | MRU 8 | 996-tone RU 3 + 484-tone RU 7; [996-tone RU − 484-tone RU − |
| | | (gap-484-tone RU)] in upper 160 MHz |
| 2 × 996 + | MRU 1 | 996-tone RU 2 + 996-tone RU 3 + 484-tone RU 2; [(gap-484-tone RU) − |
| 484-tone MRU | | 484-tone RU − 996-tone RU − 996-tone RU − (gap-996-tone RU)] |
| | MRU 2 | 996-tone RU 2 + 996-tone RU 3 + 484-tone RU 1; [484-tone RU − (gap- |
| | | 484-tone RU) − 996-tone RU − 996-tone RU − (gap-996-tone RU)] |
| | MRU 3 | 996-tone RU 1 + 996-tone RU 3 + 484-tone RU 4; [996-tone RU − (gap- |
| | | 484-tone RU) − 484-tone RU − 996-tone RU − (gap-996-tone RU)] |
| | MRU 4 | 996-tone RU 1 + 996-tone RU 3 + 484-tone RU 3; [996-tone RU − 484- |
| | | tone RU − (gap-484-tone RU) − 996-tone RU − (gap-996-tone RU)] |
| | MRU 5 | 996-tone RU 1 + 996-tone RU 2 + 484-tone RU 6; [996-tone RU − 996- |
| | | tone RU − (gap-484-tone RU) − 484-tone RU − (gap-996-tone RU)] |
| | MRU 6 | 996-tone RU 1 + 996-tone RU 2 + 484-tone RU 5; [996-tone RU − 996- |
| | | tone RU − 484-tone RU − (gap-484-tone RU) − (gap-996-tone RU)] |
| | MRU 7 | 996-tone RU 3 + 996-tone RU 4 + 484-tone RU 4; [(gap-996-tone RU) − |
| | | (gap-484-tone RU) − 484-tone RU − 996-tone RU − 996-tone RU] |
| | MRU 8 | 996-tone RU 3 + 996-tone RU 4 + 484-tone RU 3; [(gap-996-tone RU) − |
| | | 484-tone RU − (gap-484-tone RU) − 996-tone RU − 996-tone RU] |
| | MRU 9 | 996-tone RU 2 + 996-tone RU 4 + 484-tone RU 6; [(gap-996-tone RU) − |
| | | 996-tone RU − (gap-484-tone RU) − 484-tone RU − 996-tone RU] |
| | MRU 10 | 996-tone RU 2 + 996-tone RU 4 + 484-tone RU 5; [(gap-996-tone RU) − |
| | | 996-tone RU − 484-tone RU − (gap-484-tone RU) − 996-tone RU] |
| | MRU 11 | 996-tone RU 2 + 996-tone RU 3 + 484-tone RU 8; [(gap-996-tone RU) − |
| | | 996-tone RU − 996-tone RU − (gap-484-tone RU) − 484-tone RU] |
| | MRU 12 | 996-tone RU 2 + 996-tone RU 3 + 484-tone RU 7; [(gap-996-tone RU) − |
| | | 996-tone RU − 996-tone RU − 484-tone RU − (gap-484-tone RU)] |
| 3 × 996-tone | MRU 1 | 996-tone RU 2 + 996-tone RU 3 + 996-tone RU 4; [(gap-996-tone RU) − |
| MRU | | 996-tone RU − 996-tone RU − 996-tone RU] |
| | MRU 2 | 996-tone RU 1 + 996-tone RU 3 + 996-tone RU 4; [996-tone RU − (gap- |
| | | 996-tone RU) − 996-tone RU − 996-tone RU] |
| | MRU 3 | 996-tone RU 1 + 996-tone RU 2 + 996-tone RU 4; [996-tone RU − 996- |
| | | tone RU − (gap-996-tone RU) − 996-tone RU] |
| | MRU 4 | 996-tone RU 1 + 996-tone RU 2 + 996-tone RU 3; [996-tone RU − 996- |
| | | tone RU − 996-tone RU − (gap-996-tone RU)] |
| 3 × 996 + | MRU 1 | 996-tone RU 2 + 996-tone RU 3 + 996-tone RU 4 + 484-tone RU 2; [(gap- |
| 484-tone MRU | | 484-tone RU) − 484-tone RU − 996-tone RU − 996-tone RU − 996-tone RU] |
| | MRU 2 | 996-tone RU 2 + 996-tone RU 3 + 996-tone RU 4 + 484-tone RU 1; [484- |
| | | tone RU − (gap-484-tone RU) − 996-tone RU − 996-tone RU − 996-tone RU] |
| | MRU 3 | 996-tone RU 1 + 996-tone RU 3 + 996-tone RU 4 + 484-tone RU 4; [996- |
| | | tone RU − (gap-484-tone RU) − 484-tone RU − 996-tone RU − 996-tone RU] |
| | MRU 4 | 996-tone RU 1 + 996-tone RU 3 + 996-tone RU 4 + 484-tone RU 3; [996- |
| | | tone RU − 484-tone RU − (gap-484-tone RU) − 996-tone RU − 996-tone RU] |
| | MRU 5 | 996-tone RU 1 + 996-tone RU 2 + 996-tone RU 4 + 484-tone RU 6; [996- |
| | | tone RU − 996-tone RU − (gap-484-tone RU) − 484-tone RU − 996-tone RU] |
| | MRU 6 | 996-tone RU 1 + 996-tone RU 2 + 996-tone RU 4 + 484-tone RU 5; [996- |
| | | tone RU − 996-tone RU − 484-tone RU − (gap-484-tone RU) − 996-tone RU] |
| | MRU 7 | 996-tone RU 1 + 996-tone RU 2 + 996-tone RU 3 + 484-tone RU 8; [996- |
| | | tone RU − 996-tone RU − 996-tone RU − (gap-484-tone RU) − 484-tone RU] |
| | MRU 8 | 996-tone RU 1 + 996-tone RU 2 + 996-tone RU 3 + 484-tone RU 7; [996- |
| | | tone RU − 996-tone RU − 996-tone RU − 484-tone RU − (gap-484-tone RU)] |

NOTE 1
“Gap-242/484/996-tone RU” is not part of a MRU and is used to indicate the size of a gap between RUs that form the MRU.
NOTE 2
In non-OFDMA transmission, “gap-242/484/996-tone RU” indicates that one or more 20 MHz subchannels corresponding to “gap-242/484/996-tone RU” are punctured and is to help indicate the frequency order of the MRU in an 80/160/320 MHz PPDU.
NOTE 3
In OFDMA transmission, “gap-242/484/996-tone RU” indicates that one or more 20 MHz subchannels corresponding to “gap-242/484/996-tone RU” are punctured or unassigned or used for data transmission by assigning one or multiple RU/MRU and is to help indicate the frequency order of the MRU within an 80/160/240/320 MHz subband.

The RU Allocation subfield may indicate the RU location of the EHT STA allocated to the EHT PPDU among DL A-PPDUs. Depending on the BW indicated by the actual UL BW and UL BW Extension subfield (which actually indicates the bandwidth of the DL EHT PPDU), B0 and PS160 subfield can be set as described above. Regardless of BW, it may always be set based on 160 MHz (since it is allocated within Secondary 160 MHz). In this case, a new subfield may be needed to distinguish the HE/EHT variant User Info field. When using a new Trigger frame variant, the HE/EHT Indication subfield (a different name may be used) can be defined in the HE/EHT variant User Info field. If the value of the HE/EHT Indication subfield is 0, it may indicate the HE variant User Info field. If the value of the HE/EHT Indication subfield is 1, it may indicate the EHT variant User Info field. Or, it can always be set based on 320 MHz regardless of BW. Among DL A-PPDUs, it is a PPDU transmitted on Secondary 160 MHz and is used to differentiate the HE/EHT variant User Info field (if there is no HE/EHT Indication subfield). It may be desirable for the actual EHT PPDU to be set based on the RU Allocation subfield indicating RU allocation of 320 MHz and Secondary 160 MHz.

The UL FEC Coding Type subfield can be reinterpreted as the DL FEC Coding Type subfield, and among the DL A-PPDUs, The UL FEC Coding Type subfield may indicate the FEC coding type used for the data part transmitted to the EHT STA assigned to the EHT PPDU (i.e., indicated by the AID). When using a new trigger frame variant, the UL FEC Coding Type subfield can be changed to the DL FEC Coding Type subfield (a different name may be used).

The UL EHT-MCS subfield can be reinterpreted as the DL EHT-MCS subfield, and among the DL A-PPDUs, the UL EHT-MCS subfield may indicate EHT-MCS used in the data part transmitted to the EHT STA assigned to the EHT PPDU (i.e., indicated by the AID). When using a new trigger frame variant, the UL EHT-MCS subfield may be changed to the DL EHT-MCS subfield (a different name may be used).

The Reserved subfield can be reserved and set to 0, or removed when using a new Trigger frame variant. If the UL DCM subfield is present in the HE variant User Info field, it may be desirable to always reserve it and set it to 0.

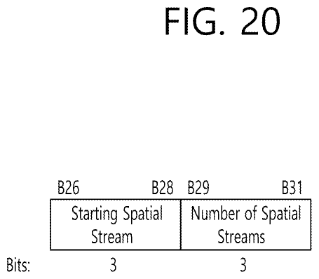

FIG. 20 shows an example of a SS Allocation subfield format.

The SS Allocation subfield in FIG. 20 may be the SS Allocation subfield of the HE/EHT variant User Info field.

The SS Allocation subfield indicates the number of spatial streams used in the data part transmitted to the EHT STA allocated to the EHT PPDU (i.e., indicated by the AID) among the DL A-PPDUs.

The UL Target Receive Power subfield may be reserved or removed when using a new Trigger frame variant.

PS160 subfield can be set to 1. The PS160 subfield and the Reserved subfield of the HE Variant User Info field are in the same location. The HE/EHT variant User Info field can be distinguished by the value of 0 or 1.

The Trigger Dependent User Info subfield can be removed.

As suggested above, the AP can reuse the existing trigger frame as much as possible to instruct the EHT STA in advance about information for DL A-PPDU transmission. When actually transmitting DL A-PPDU, the existing HE SU/MU PPDU and EHT MU PPDU can be used as is. In this case, most of the information in the above trigger frame is also included in the DL A-PPDU. Since this indicates duplicate information, the information transmitted in the trigger frame may not be included when transmitting the DL A-PPDU (the corresponding field may be reserved or removed from the HE/EHT PPDU within the DL A-PPDU, but it may be desirable to reserve it to match the format). However, this may not be desirable because the structures of HE SU/MU PPDU and EHT MU PPDU may be different. Therefore, the structure of HE SU/MU PPDU and EHT MU PPDU can be maintained and the corresponding information can be indicated as is. However, it may be desirable to transmit only the minimum information included in the trigger frame. In this case, the trigger type may be a new type. The Common Info field, Special User Info field, HE variant User Info field, and EHT variant User Info field described below may be fields within a new type of trigger frame composed of the minimum number of subfields.

Common Info field: Includes Trigger Type subfield (set to a new value, e.g. 8) and UL BW subfield, and the remaining subfields can be used as is or reserved to set the length of the Common Info field to 8 or more octets.

Special User Info field (may correspond to the Trigger Dependent Common Info subfield of the Common Info field): AID12 subfield (set to 2007, may not be present if included in the Common Info field), PHY Version ID subfield (if used the same after EHT) (may be included), UL BW Extension subfield, Reserved subfield (if necessary)

HE variant User Info field: AID12 subfield, RU Allocation subfield, Reserved subfield (number of bits corresponding to PS160), HE/EHT Indication subfield (may not be present), Reserved subfield (if necessary)

EHT variant User Info field: AID12 subfield, RU Allocation subfield, PS160 subfield, HE/EHT Indication subfield (may not exist), Reserved subfield (if necessary)

Above, a Special User Info field can be located within the Common Info field (it is not included within the Trigger Dependent Common Info subfield). In other words, the Common Info field can be configured as follows.

Common Info field: Trigger Type subfield (4 bits, set to new value, example 8), UL BW subfield (2 bits), UL BW Extension subfield (2 bits), Reserved subfield (7 octets)

Additionally, the Common Info field may include a 3-bit PHY Version ID subfield. In this case, the Reserved subfield is 53 bits.

When transmitting DL A-PPDU using various trigger frames suggested above, even when SST is not used, an EHT STA can be effectively assigned to a channel on which HE/EHT PPDU is transmitted. It can be especially effective for EHT STAs operating at 320 MHz.

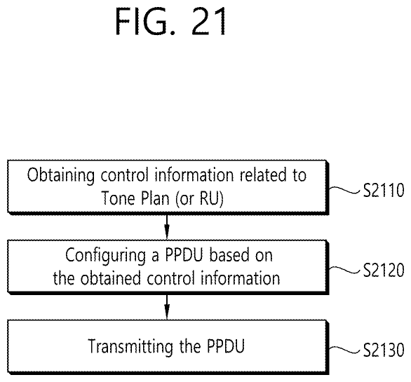

FIG. 21 is a process flow diagram illustrating the operation of the transmitting device according to this embodiment.

The example of FIG. 21 may be performed by a transmitting STA or a transmitting device (AP and/or non-AP STA).

Some of each step (or detailed sub-steps to be described later) in the example of FIG. 21 may be omitted or changed.

Through step S2110, the transmitting device (transmitting STA) may obtain information about the above-described tone plan. As described above, the information about the tone plan includes the size and location of the RU, control information related to the RU, information about a frequency band including the RU, information about an STA receiving the RU, and the like.

Through step S2120, the transmitting device may configure/generate a PPDU based on the acquired control information. A step of configuring/generating the PPDU may include a step of configuring/generating each field of the PPDU. That is, step S2120 includes a step of configuring the EHT-SIG field including control information about the tone plan. That is, step S1420 may include a step of configuring a field including control information (e.g. N bitmaps) indicating the size/position of the RU and/or a step of configuring a field including an identifier of an STA (e.g. AID) receiving the RU.

Also, step S2120 may include a step of generating an STF/LTF sequence transmitted through a specific RU. The STF/LTF sequence may be generated based on a preset STF generation sequence/LTF generation sequence.

Also, step S2120 may include a step of generating a data field (i.e., MPDU) transmitted through a specific RU.

The transmitting device may transmit the PPDU constructed through step S2120 to the receiving device based on step S2130.

While performing step S2130, the transmitting device may perform at least one of operations such as CSD, Spatial Mapping, IDFT/IFFT operation, and GI insertion.

A signal/field/sequence constructed according to the present specification may be transmitted in the form of FIG. 10.

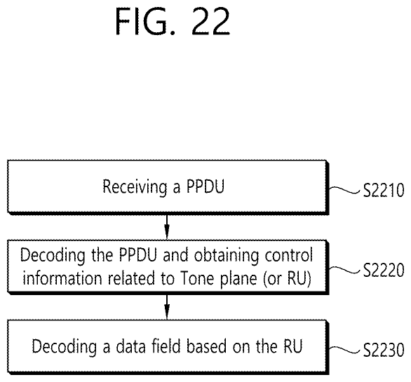

FIG. 22 is a process flow diagram illustrating the operation of the receiving device according to the present embodiment.

The aforementioned PPDU may be received according to the example of FIG. 22.

The example of FIG. 22 may be performed by a receiving STA or a receiving device (AP and/or non-AP STA).

Some of each step (or detailed sub-steps to be described later) in the example of FIG. 22 may be omitted.

The receiving device (receiving STA) may receive all or part of the PPDU through step S2210. The received signal may be in the form of FIG. 10.

The sub-step of step S1510 may be determined based on step S2130 of FIG. 21. That is, in step S2210, an operation of restoring the result of the CSD, Spatial Mapping, IDFT/IFFT operation, and GI insertion operation applied in step S2130 may be performed.

In step S2220, the receiving device may perform decoding on all/part of the PPDU. Also, the receiving device may obtain control information related to a tone plan (i.e., RU) from the decoded PPDU.

More specifically, the receiving device may decode the L-SIG and EHT-SIG of the PPDU based on the legacy STF/LTF and obtain information included in the L-SIG and EHT SIG fields. Information on various tone plans (i.e., RUs) described in this specification may be included in the EHT-SIG, and the receiving STA may obtain information on the tone plan (i.e., RU) through the EHT-SIG.

In step S2230, the receiving device may decode the remaining part of the PPDU based on information about the tone plan (i.e., RU) acquired through step S2220. For example, the receiving STA may decode the STF/LTF field of the PPDU based on information about one plan (i.e., RU). In addition, the receiving STA may decode the data field of the PPDU based on information about the tone plan (i.e., RU) and obtain the MPDU included in the data field.

In addition, the receiving device may perform a processing operation of transferring the data decoded through step S2230 to a higher layer (e.g., MAC layer). In addition, when generation of a signal is instructed from the upper layer to the PHY layer in response to data transmitted to the upper layer, a subsequent operation may be performed.

Hereinafter, the above-described embodiment will be described with reference to FIG. 1 to FIG. 22.

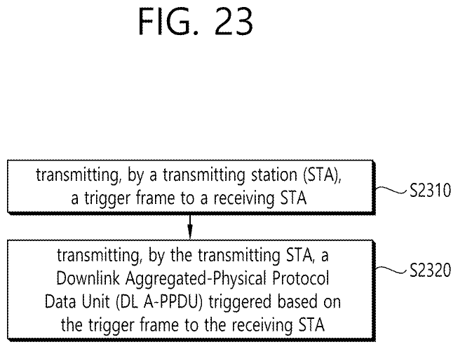

FIG. 23 is a flowchart illustrating a procedure in which a transmitting STA transmits a trigger frame that triggers a DL A-PPDU according to this embodiment.

The example of FIG. 23 may be performed in a network environment in which a next generation WLAN system (IEEE 802.11be or EHT WLAN system) is supported. The next generation wireless LAN system is a WLAN system that is enhanced from an 802.11ax system and may, therefore, satisfy backward compatibility with the 802.11ax system.

The example of FIG. 23 is performed by a transmitting STA, and the transmitting STA may correspond to an access point (AP) STA. The receiving STA may correspond to a non-AP STA.

This embodiment proposes a method in which an AP configures a trigger frame to trigger a DL A-PPDU in which a HE PPDU and an EHT PPDU are transmitted simultaneously. An EHT STA that received the trigger frame can receive control information for the DL A-PPDU through the trigger frame.

In step S2310, a transmitting station (STA) transmits a trigger frame to a receiving STA.

In step S2320, the transmitting STA transmits a Downlink Aggregated-Physical Protocol Data Unit (DL A-PPDU) triggered based on the trigger frame to the receiving STA.

The DL A-PPDU includes a High Efficiency (HE) PPDU for a primary 160 MHz channel and an Extreme High Throughput (EHT) PPDU for a secondary 160 MHz channel.

The trigger frame may include a common information field, a HE variant user information field, and an EHT variant user information field.

The common information field includes a trigger type subfield, a Downlink Bandwidth (DL BW) subfield, a DL BW Extension subfield, and a first reserved subfield.

The HE variant user information field includes a first AID12 subfield, a first Resource Unit (RU) allocation subfield, and a second reserved subfield.

The EHT variant user information field includes a second AID12 subfield, a second RU allocation subfield, and a PS160 subfield.

A bit position of the second reserved subfield in the HE variant user information field is the same as a bit position of the PS160 subfield in the EHT variant user information field.

The trigger type subfield may include information on a type of the trigger frame. When a value of the trigger type subfield is 8, the trigger frame may be set to a type that triggers the DL A-PPDU.

The embodiment proposes a method in which the transmitting STA newly defines a trigger frame that triggers the DL A-PPDU and transmits the trigger frame with minimum information compared to an existing trigger frame. When the transmitting STA transmits the DL A-PPDU based on the trigger frame, even when Subchannel Selective Transmission (SST) is not used, there is an effect that an EHT STA can be effectively assigned to the channel on which the HE PPDU and the EHT PPDU are transmitted.

The minimum information may include the trigger type subfield, the DL BW subfield, the DL BW Extension subfield and the first reserved subfield included in the common information field, the first AID12 subfield, the first RU allocation subfield, the second reserved subfield included in the HE variant user information field, and the second AID12 subfield, the second RU allocation subfield, and the PS160 subfield included in the EHT variant user information field. The above minimum information can be explained as follows.

Values of the first and second AID12 subfields may be set to 0, 2007, 2045, or 2046 or are reserved.

The DL BW subfield may include information on a bandwidth of the HE PPDU. The DL BW Extension subfield may include information on a bandwidth of the EHT PPDU. Referring to Table 6, the bandwidth of the HE PPDU and the bandwidth of the EHT PPDU may be indicated according to the values of the DL BW subfield and the DL BW Extension subfield.

The first RU allocation subfield may include allocation information for a first RU defined in the HE wireless LAN system in the primary 160 MHz channel based on the DL BW subfield.

The first RU allocation subfield may consist of first to eighth bits.

The primary 160 MHz channel includes a primary 80 MHz channel and a secondary 80 MHz channel.

The first bit may indicate whether the first RU allocation subfield is allocation information for the first RU in the primary 80 MHz channel or allocation information for the first RU in the secondary 80 MHz channel.

The second to eighth bits may indicate a size and location of the first RU in the primary 80 MHz channel or the secondary 80 MHz channel. Referring to Table 7, the size and location of the first RU may be indicated according to the values of the second to eighth bits (B1-B7). In particular, the location of the first RU may be indicated by a RU index, which may be indicated based on Tables 8 and 9.

When the bandwidth of the HE PPDU is 20 MHz, 40 MHz, or 80 MHz, the first bit may be always set to 0. When the bandwidth of the HE PPDU is 80+80 MHz or 160 MHz and the first RU allocation subfield is the allocation information for the first RU in the primary 80 MHz channel, the first bit may be set to 0. When the bandwidth of the HE PPDU is 80+80 MHz or 160 MHz and the first RU allocation subfield is the allocation information for the first RU in the secondary 80 MHz channel, the first bit may be set to 1.

The second RU allocation subfield may include allocation information for the second RU defined in the EHT wireless LAN system in the secondary 160 MHz channel based on the DL BW subfield, the DL BW Extension subfield, and the PS160 subfield.

The second RU allocation field may consist of the ninth to sixteenth bits.

The secondary 160 MHz channel may include a first 80 MHz channel with a low frequency and a second 80 MHz channel with a high frequency.

The ninth bit may indicate whether the second RU allocation subfield is allocation information for the second RU in the first 80 MHz channel or allocation information for the second RU in the second 80 MHz channel.

The tenth to sixteenth bits may indicate a size and location of the second RU in the first 80 MHz channel or the second 80 MHz channel. Referring to Table 10, the size and location of the second RU may be indicated according to the values of the 10th to 16th bits (B1-B7). In particular, the location of the second RU may be indicated by a RU/MRU index, which may be indicated based on Tables 12 to 23.

The second RU in the first 80 MHz channel or the second 80 MHz channel may include a 26-tone RU, a 52-tone RU, a 106-tone RU, a 242-tone RU, a 484-tone RU, a 996-tone RU, a 52+26-tone Multi Resource Unit (MRU), a 106+26-tone MRU and a 484+242-tone MRU. The second RU in the secondary 160 MHz channel may include a 2×996-tone RU, a 996+484-tone MRU, and a 996+484+242-tone MRU.

The value of the second reserved subfield may be 0, and the value of the PS160 subfield may be 1. If the HE variant user information field is a field including information for the EHT STA allocated to the HE PPDU among the DL A-PPDUs and the EHT variant user information field is a field including information for the EHT STA allocated to the EHT PPDU among the DL A-PPDUs, the value of the second reserved subfield may always be 0, and the value of the PS160 subfield may always be 1.

The trigger type subfield may be 4 bits, the DL BW subfield may be 2 bits, the DL BW Extension subfield may be 2 bits, and the first reserved subfield may be 7 octets. The HE/EHT variant user information field may further include additional reserved subfields, if necessary.

As another example, the trigger frame may include only a common information field and a user information field. The common information field may include a trigger type field, a DL BW subfield, a DL BW Extension subfield, and a first reserved subfield, as in the above-described embodiment. The user information field may include an AID12 subfield, a RU allocation subfield, a PS160 subfield, and a second reserved subfield. If the value of the PS160 subfield is 0, the RU allocation subfield may include RU allocation information defined in the HE wireless LAN system. If the value of the PS160 subfield is 1, the RU allocation subfield may include RU allocation information defined in the EHT wireless LAN system.

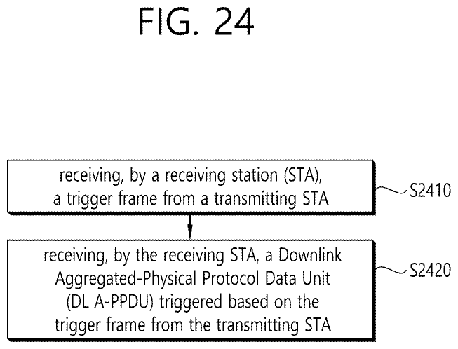

FIG. 24 is a flowchart illustrating a procedure in which a receiving STA receives a trigger frame that triggers a DL A-PPDU according to this embodiment.

The example of FIG. 24 may be performed in a network environment in which a next generation WLAN system (IEEE 802.11be or EHT WLAN system) is supported. The next generation wireless LAN system is a WLAN system that is enhanced from an 802.11ax system and may, therefore, satisfy backward compatibility with the 802.11ax system.

The example of FIG. 24 may be performed by a receiving station (STA), and the receiving STA may correspond to a non-access point (non-AP) STA. The receiving STA may correspond to an AP STA.

This embodiment proposes a method in which an AP configures a trigger frame to trigger a DL A-PPDU in which a HE PPDU and an EHT PPDU are transmitted simultaneously. An EHT STA that received the trigger frame can receive control information for the DL A-PPDU through the trigger frame.

In step S2410, a receiving station (STA) receives a trigger frame from a transmitting STA.

In step S2420, the receiving STA receives a Downlink Aggregated-Physical Protocol Data Unit (DL A-PPDU) triggered based on the trigger frame from the transmitting STA.

The DL A-PPDU includes a High Efficiency (HE) PPDU for a primary 160 MHz channel and an Extreme High Throughput (EHT) PPDU for a secondary 160 MHz channel.

The trigger frame may include a common information field, a HE variant user information field, and an EHT variant user information field.

The common information field includes a trigger type subfield, a Downlink Bandwidth (DL BW) subfield, a DL BW Extension subfield, and a first reserved subfield.

The HE variant user information field includes a first AID12 subfield, a first Resource Unit (RU) allocation subfield, and a second reserved subfield.

The EHT variant user information field includes a second AID12 subfield, a second RU allocation subfield, and a PS160 subfield.

A bit position of the second reserved subfield in the HE variant user information field is the same as a bit position of the PS160 subfield in the EHT variant user information field.

The trigger type subfield may include information on a type of the trigger frame. When a value of the trigger type subfield is 8, the trigger frame may be set to a type that triggers the DL A-PPDU.

The embodiment proposes a method in which the transmitting STA newly defines a trigger frame that triggers the DL A-PPDU and transmits the trigger frame with minimum information compared to an existing trigger frame. When the transmitting STA transmits the DL A-PPDU based on the trigger frame, even when Subchannel Selective Transmission (SST) is not used, there is an effect that an EHT STA can be effectively assigned to the channel on which the HE PPDU and the EHT PPDU are transmitted.

The minimum information may include the trigger type subfield, the DL BW subfield, the DL BW Extension subfield and the first reserved subfield included in the common information field, the first AID12 subfield, the first RU allocation subfield, the second reserved subfield included in the HE variant user information field, and the second AID12 subfield, the second RU allocation subfield, and the PS160 subfield included in the EHT variant user information field. The above minimum information can be explained as follows.

Values of the first and second AID12 subfields may be set to 0, 2007, 2045, or 2046 or are reserved.

The DL BW subfield may include information on a bandwidth of the HE PPDU. The DL BW Extension subfield may include information on a bandwidth of the EHT PPDU. Referring to Table 6, the bandwidth of the HE PPDU and the bandwidth of the EHT PPDU may be indicated according to the values of the DL BW subfield and the DL BW Extension subfield.

The first RU allocation subfield may include allocation information for a first RU defined in the HE wireless LAN system in the primary 160 MHz channel based on the DL BW subfield.

The first RU allocation subfield may consist of first to eighth bits.

The primary 160 MHz channel includes a primary 80 MHz channel and a secondary 80 MHz channel.

The first bit may indicate whether the first RU allocation subfield is allocation information for the first RU in the primary 80 MHz channel or allocation information for the first RU in the secondary 80 MHz channel.

The second to eighth bits may indicate a size and location of the first RU in the primary 80 MHz channel or the secondary 80 MHz channel. Referring to Table 7, the size and location of the first RU may be indicated according to the values of the second to eighth bits (B1-B7). In particular, the location of the first RU may be indicated by a RU index, which may be indicated based on Tables 8 and 9.

When the bandwidth of the HE PPDU is 20 MHz, 40 MHz, or 80 MHz, the first bit may be always set to 0. When the bandwidth of the HE PPDU is 80+80 MHz or 160 MHz and the first RU allocation subfield is the allocation information for the first RU in the primary 80 MHz channel, the first bit may be set to 0. When the bandwidth of the HE PPDU is 80+80 MHz or 160 MHz and the first RU allocation subfield is the allocation information for the first RU in the secondary 80 MHz channel, the first bit may be set to 1.

The second RU allocation subfield may include allocation information for the second RU defined in the EHT wireless LAN system in the secondary 160 MHz channel based on the DL BW subfield, the DL BW Extension subfield, and the PS160 subfield.

The second RU allocation field may consist of the ninth to sixteenth bits.

The secondary 160 MHz channel may include a first 80 MHz channel with a low frequency and a second 80 MHz channel with a high frequency.

The ninth bit may indicate whether the second RU allocation subfield is allocation information for the second RU in the first 80 MHz channel or allocation information for the second RU in the second 80 MHz channel.

The tenth to sixteenth bits may indicate a size and location of the second RU in the first 80 MHz channel or the second 80 MHz channel. Referring to Table 10, the size and location of the second RU may be indicated according to the values of the 10th to 16th bits (B1-B7). In particular, the location of the second RU may be indicated by a RU/MRU index, which may be indicated based on Tables 12 to 23.

The second RU in the first 80 MHz channel or the second 80 MHz channel may include a 26-tone RU, a 52-tone RU, a 106-tone RU, a 242-tone RU, a 484-tone RU, a 996-tone RU, a 52+26-tone Multi Resource Unit (MRU), a 106+26-tone MRU and a 484+242-tone MRU. The second RU in the secondary 160 MHz channel may include a 2×996-tone RU, a 996+484-tone MRU, and a 996+484+242-tone MRU.

The value of the second reserved subfield may be 0, and the value of the PS160 subfield may be 1. If the HE variant user information field is a field including information for the EHT STA allocated to the HE PPDU among the DL A-PPDUs and the EHT variant user information field is a field including information for the EHT STA allocated to the EHT PPDU among the DL A-PPDUs, the value of the second reserved subfield may always be 0, and the value of the PS160 subfield may always be 1.

The trigger type subfield may be 4 bits, the DL BW subfield may be 2 bits, the DL BW Extension subfield may be 2 bits, and the first reserved subfield may be 7 octets. The HE/EHT variant user information field may further include additional reserved subfields, if necessary. As another example, the trigger frame may include only a common information field and a user information field. The common information field may include a trigger type field, a DL BW subfield, a DL BW Extension subfield, and a first reserved subfield, as in the above-described embodiment. The user information field may include an AID12 subfield, a RU allocation subfield, a PS160 subfield, and a second reserved subfield. If the value of the PS160 subfield is 0, the RU allocation subfield may include RU allocation information defined in the HE wireless LAN system. If the value of the PS160 subfield is 1, the RU allocation subfield may include RU allocation information defined in the EHT wireless LAN system.

### 4. Device Configuration

The technical features of the present disclosure may be applied to various devices and methods. For example, the technical features of the present disclosure may be performed/supported through the device(s) of FIG. 1 and/or FIG. 11. For example, the technical features of the present disclosure may be applied to only part of FIG. 1 and/or FIG. 11. For example, the technical features of the present disclosure may be implemented based on the processing chip(s) 114 and 124 of FIG. 1, or implemented based on the processor(s) 111 and 121 and the memory(s) 112 and 122, or implemented based on the processor 610 and the memory 620 of FIG. 11. For example, the device according to the present disclosure receives a trigger frame from a transmitting station (STA); and receives a Downlink Aggregated-Physical Protocol Data Unit (DL A-PPDU) triggered based on the trigger frame from the transmitting STA.

The technical features of the present disclosure may be implemented based on a computer readable medium (CRM). For example, a CRM according to the present disclosure is at least one computer readable medium including instructions designed to be executed by at least one processor.

The CRM may store instructions that perform operations including receiving a trigger frame from a transmitting station (STA); and receiving a Downlink Aggregated-Physical Protocol Data Unit (DL A-PPDU) triggered based on the trigger frame from the transmitting STA. At least one processor may execute the instructions stored in the CRM according to the present disclosure. At least one processor related to the CRM of the present disclosure may be the processor 111, 121 of FIG. 1, the processing chip 114, 124 of FIG. 1, or the processor 610 of FIG. 11. Meanwhile, the CRM of the present disclosure may be the memory 112, 122 of FIG. 1, the memory 620 of FIG. 11, or a separate external memory/storage medium/disk.

The foregoing technical features of the present specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims recited in the present specification may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

1. A method in a wireless local area network (WLAN) system, the method comprising:
receiving, by a receiving station (STA), a trigger frame from a transmitting STA; and
receiving, by the receiving STA, a Downlink Aggregated-Physical Protocol Data Unit (DL A-PPDU) triggered based on the trigger frame from the transmitting STA,
wherein the DL A-PPDU includes a High Efficiency (HE) PPDU for a primary 160 MHz channel and an Extreme High Throughput (EHT) PPDU for a secondary 160 MHz channel,
wherein the trigger frame may include a common information field, a HE variant user information field, and an EHT variant user information field,
wherein the common information field includes a trigger type subfield, a Downlink Bandwidth (DL BW) subfield, a DL BW Extension subfield, and a first reserved subfield,
wherein the second U-SIG field includes a Validate field, and
wherein the HE variant user information field includes a first AID12 subfield, a first Resource Unit (RU) allocation subfield, and a second reserved subfield,
wherein the EHT variant user information field includes a second AID12 subfield, a second RU allocation subfield, and a PS160 subfield, and
wherein a bit position of the second reserved subfield in the HE variant user information field is the same as a bit position of the PS160 subfield in the EHT variant user information field.

2. The method of claim 1, wherein the trigger type subfield may include information on a type of the trigger frame,
wherein when a value of the trigger type subfield is 8, the trigger frame is set to a type that triggers the DL A-PPDU.

3. The method of claim 1, wherein values of the first and second AID12 subfields are set to 0, 2007, 2045, or 2046 or are reserved.

4. The method of claim 1, wherein the DL BW subfield includes information on a bandwidth of the HE PPDU,
wherein the DL BW Extension subfield includes information on a bandwidth of the EHT PPDU.

5. The method of claim 4, wherein the first RU allocation subfield includes allocation information for a first RU defined in the HE wireless LAN system in the primary 160 MHz channel based on the DL BW subfield,
wherein the first RU allocation subfield consists of first to eighth bits,
wherein the primary 160 MHz channel includes a primary 80 MHz channel and a secondary 80 MHz channel,
wherein the first bit indicates whether the first RU allocation subfield is allocation information for the first RU in the primary 80 MHz channel or allocation information for the first RU in the secondary 80 MHz channel,
wherein the second to eighth bits indicate a size and location of the first RU in the primary 80 MHz channel or the secondary 80 MHz channel.

6. The method of claim 5, wherein when the bandwidth of the HE PPDU is 20 MHz, 40 MHz, or 80 MHz, the first bit is always set to 0,
wherein when the bandwidth of the HE PPDU is 80+80 MHz or 160 MHz and the first RU allocation subfield is the allocation information for the first RU in the primary 80 MHz channel, the first bit is set to 0,
wherein when the bandwidth of the HE PPDU is 80+80 MHz or 160 MHz and the first RU allocation subfield is the allocation information for the first RU in the secondary 80 MHz channel, the first bit is set to 1.

7. The method of claim 4, wherein the second RU allocation subfield includes allocation information for the second RU defined in the EHT wireless LAN system in the secondary 160 MHz channel based on the DL BW subfield, the DL BW Extension subfield, and the PS160 subfield,
wherein the second RU allocation field consists of the ninth to sixteenth bits,
wherein the secondary 160 MHz channel includes a first 80 MHz channel with a low frequency and a second 80 MHz channel with a high frequency,
wherein the ninth bit indicates whether the second RU allocation subfield is allocation information for the second RU in the first 80 MHz channel or allocation information for the second RU in the second 80 MHz channel,
wherein the tenth to sixteenth bits indicate a size and location of the second RU in the first 80 MHz channel or the second 80 MHz channel.

8. The method of claim 7, wherein the second RU in the first 80 MHz channel or the second 80 MHz channel includes a 26-tone RU, a 52-tone RU, a 106-tone RU, a 242-tone RU, a 484-tone RU, a 996-tone RU, a 52+26-tone Multi Resource Unit (MRU), a 106+26-tone MRU and a 484+242-tone MRU,
wherein the second RU in the secondary 160 MHz channel includes a 2×996-tone RU, a 996+484-tone MRU, and a 996+484+242-tone MRU.

9. The method of claim 8, wherein a value of the second reserved subfield is 0, and a value of the PS160 subfield is 1.

10. A receiving station (STA) in a wireless local area network (WLAN) system, the receiving STA comprising:
a memory;
a transceiver; and
a processor being operatively connected to the memory and the transceiver,
wherein the processor is configured to:
receive a trigger frame from a transmitting STA; and
receive a Downlink Aggregated-Physical Protocol Data Unit (DL A-PPDU) triggered based on the trigger frame from the transmitting STA,
wherein the DL A-PPDU includes a High Efficiency (HE) PPDU for a primary 160 MHz channel and an Extreme High Throughput (EHT) PPDU for a secondary 160 MHz channel,
wherein the trigger frame may include a common information field, a HE variant user information field, and an EHT variant user information field,
wherein the common information field includes a trigger type subfield, a Downlink Bandwidth (DL BW) subfield, a DL BW Extension subfield, and a first reserved subfield,
wherein the second U-SIG field includes a Validate field, and
wherein the HE variant user information field includes a first AID12 subfield, a first Resource Unit (RU) allocation subfield, and a second reserved subfield,
wherein the EHT variant user information field includes a second AID12 subfield, a second RU allocation subfield, and a PS160 subfield, and
wherein a bit position of the second reserved subfield in the HE variant user information field is the same as a bit position of the PS160 subfield in the EHT variant user information field.

11. A method in a wireless local area network (WLAN) system, the method comprising:
transmitting, by a transmitting station (STA), a trigger frame to a receiving STA; and
transmitting, by the transmitting STA, a Downlink Aggregated-Physical Protocol Data Unit (DL A-PPDU) triggered based on the trigger frame to the receiving STA,
wherein the DL A-PPDU includes a High Efficiency (HE) PPDU for a primary 160 MHz channel and an Extreme High Throughput (EHT) PPDU for a secondary 160 MHz channel,
wherein the trigger frame may include a common information field, a HE variant user information field, and an EHT variant user information field,
wherein the common information field includes a trigger type subfield, a Downlink Bandwidth (DL BW) subfield, a DL BW Extension subfield, and a first reserved subfield,
wherein the second U-SIG field includes a Validate field, and
wherein the HE variant user information field includes a first AID12 subfield, a first Resource Unit (RU) allocation subfield, and a second reserved subfield,
wherein the EHT variant user information field includes a second AID12 subfield, a second RU allocation subfield, and a PS160 subfield, and
wherein a bit position of the second reserved subfield in the HE variant user information field is the same as a bit position of the PS160 subfield in the EHT variant user information field.

12. The method of claim 11, wherein the trigger type subfield may include information on a type of the trigger frame,
wherein when a value of the trigger type subfield is 8, the trigger frame is set to a type that triggers the DL A-PPDU.

13. The method of claim 11, wherein values of the first and second AID12 subfields are set to 0, 2007, 2045, or 2046 or are reserved.

14. The method of claim 11, wherein the DL BW subfield includes information on a bandwidth of the HE PPDU,
wherein the DL BW Extension subfield includes information on a bandwidth of the EHT PPDU.

15. The method of claim 14, wherein the first RU allocation subfield includes allocation information for a first RU defined in the HE wireless LAN system in the primary 160 MHz channel based on the DL BW subfield,
wherein the first RU allocation subfield consists of first to eighth bits,
wherein the primary 160 MHz channel includes a primary 80 MHz channel and a secondary 80 MHz channel,
wherein the first bit indicates whether the first RU allocation subfield is allocation information for the first RU in the primary 80 MHz channel or allocation information for the first RU in the secondary 80 MHz channel,
wherein the second to eighth bits indicate a size and location of the first RU in the primary 80 MHz channel or the secondary 80 MHz channel.

16. The method of claim 15, wherein when the bandwidth of the HE PPDU is 20 MHz, 40 MHz, or 80 MHz, the first bit is always set to 0,
wherein when the bandwidth of the HE PPDU is 80+80 MHz or 160 MHz and the first RU allocation subfield is the allocation information for the first RU in the primary 80 MHz channel, the first bit is set to 0,
wherein when the bandwidth of the HE PPDU is 80+80 MHz or 160 MHz and the first RU allocation subfield is the allocation information for the first RU in the secondary 80 MHz channel, the first bit is set to 1.

17. The method of claim 14, wherein the second RU allocation subfield includes allocation information for the second RU defined in the EHT wireless LAN system in the secondary 160 MHz channel based on the DL BW subfield, the DL BW Extension subfield, and the PS160 subfield,
wherein the second RU allocation field consists of the ninth to sixteenth bits,
wherein the secondary 160 MHz channel includes a first 80 MHz channel with a low frequency and a second 80 MHz channel with a high frequency,
wherein the ninth bit indicates whether the second RU allocation subfield is allocation information for the second RU in the first 80 MHz channel or allocation information for the second RU in the second 80 MHz channel,
wherein the tenth to sixteenth bits indicate a size and location of the second RU in the first 80 MHz channel or the second 80 MHz channel.

18-20. (canceled)
